(19) United States
(12) Patent Application Publication
(10) Pub. No.: US 2026/0220700 A1
(43) Pub. Date: Jul. 30, 2026

(54) REGULATORY COMPLIANCE SYSTEM FOR TOKENIZED UNMINED GOLD DEPOSITS USING A DISTRIBUTED LEDGER NETWORK

(71) Applicant: NatGold Digital Ltd., Miami, FL (US)

(72) Inventor: Anthony Wade Wile, Carson City, NV (US)

(21) Appl. No.: 19/456,719

(22) Filed: Jan. 22, 2026

Related U.S. Application Data
(60) Provisional application No. 63/750,041, filed on Jan. 27, 2025.
(60) Provisional application No. 63/750,022, filed on Jan. 27, 2025.
(60) Provisional application No. 63/750,014, filed on Jan. 27, 2025.
(60) Provisional application No. 63/750,004, filed on Jan. 27, 2025.
(60) Provisional application No. 63/749,991, filed on Jan. 27, 2025.
(60) Provisional application No. 63/749,984, filed on Jan. 27, 2025.
(60) Provisional application No. 63/750,032, filed on Jan. 27, 2025.

(51) Int. Cl. G06Q 40/02

(52) U.S. Cl. CPC G06Q 40/024

(57) ABSTRACT

Methods and systems for implementing regulatory compliance in tokenizing verified unmined gold deposits through integrated anti-money laundering (AML) and know your customer (KYC) frameworks. The system receives source of funds documentation from a prospective titleholder and executes risk assessment calculations based on predefined money laundering risk factors. Transaction monitoring protocols detect structured transactions, identify unusual transaction patterns, and flag high-risk jurisdictional transfers. The system issues distributed ledger tokens incorporating smart contracts that encode transaction limits, establish holding periods, and implement transaction screening. For identity verification, the system validates identification documentation against external verification sources, executes enhanced due diligence protocols for high-risk customers, and implements customer risk scoring. All compliance data, including risk assessments, suspicious activity reports, and identity verifications, are recorded in a secure section of a distributed ledger maintained across a network of validating nodes.

### CROSS-REFERENCE TO RELATED APPLICATIONS

This application claims the benefit of U.S. Provisional Application No. 63/750,032, titled “System Method and Apparatus for Tokenizing Unmined Gold Deposits,” filed January 27, 2025, U.S. Provisional Application No. 63/749,984, titled “Method and System of Valuing Unmined Gold Deposits for Tokenization”, filed January 27, 2025, U.S. Provisional Application No. 63/749,991, titled “Method of Tokenization and Token Transformation to a Partially Mined Gold Deposits”, filed January 27, 2025, U.S. Provisional Application No. 63/750,004, titled “Risk Management Framework Method and System for Unmined Gold Deposits”, filed January 27, 2025, U.S. Provisional Application No. 63/750,014, titled “Central Bank Digital Currency Integration Method with Unmined Deposit Tokenization”, filed January 27, 2025, U.S. Provisional Application No. 63/750,022, titled “Anti-Money Laundering and Know Your Client Compliance Method and System for Unmined Gold Deposits”, filed January 27, 2025, and U.S. Provisional Application No. 63/750,041, titled “ESG Credit Framework Method for the Tokenization of Unmined Gold Deposits”, filed January 27, 2025, the entire disclosures of which are incorporated herein by reference.

### BACKGROUND

Natural resource assets, including mineral deposits, present particular challenges when subjected to tokenization frameworks. Unlike conventional financial instruments or readily verifiable physical commodities, unmined mineral deposits exist as geological resources that have been estimated and classified according to technical standards but have not yet been extracted from the ground. The valuation of such deposits depends on numerous factors including resource estimates, extraction feasibility, commodity prices, and regulatory considerations.

Regulatory compliance frameworks for financial transactions, including Anti-Money Laundering (AML) and Know Your Customer (KYC) protocols, have been developed primarily for traditional financial instruments and banking relationships. These frameworks establish requirements for verifying customer identities, monitoring transactions for suspicious activity, maintaining audit trails, and reporting to regulatory authorities. However, the application of these compliance frameworks to tokenized natural resource assets introduces complexities that existing systems may not adequately address.

The ownership structures associated with mining rights and mineral claims often involve multiple layers of corporate entities, joint ventures, and contractual arrangements. Tracking beneficial ownership through these complex structures presents challenges for compliance systems designed for more straightforward ownership relationships. Additionally, the global nature of both mining operations and digital asset trading creates situations where multiple jurisdictional requirements may apply simultaneously, requiring reconciliation of potentially conflicting regulatory frameworks.

Furthermore, transaction monitoring for tokenized mineral assets differs from monitoring conventional financial transactions due to the nature of the underlying assets. The valuation volatility of unmined deposits, combined with the transferability characteristics of digital tokens, creates transaction patterns that may not align with baseline parameters established for traditional financial instruments. In addition, the integration of physical asset verification with digital transaction monitoring introduces considerations that span both the geological and financial domains.

Maintaining comprehensive audit trails that capture compliance activities across multiple jurisdictions while preserving the integrity and accessibility of compliance records presents additional technical challenges.

### BRIEF SUMMARY

Aspects of the present application are directed to a system configured to implement processes relating to providing a secure, legally compliant, and environmentally conscious system for representing and trading unmined gold deposits in a digital realm (herein referred to as an “asset management system”). According to embodiments, the asset management system addresses the aforementioned regulatory compliance issues in tokenizing unmined gold deposits through an anti-money laundering (AML) sub-system or module interconnected with a know your customer (KCL) sub-system or module.

According to embodiments, the asset management system includes the AML module configured to implement an advanced transaction monitoring system that addresses the risks of tokenized unmined gold deposits. According to embodiments, the AML module enables transaction monitoring through risk assessment calculations, real-time suspicious activity detection, and blockchain-based audit trails. According to embodiments, the AML module is configured to manage and/or execute one or more of the following actions: source of funds verification, risk-based transaction monitoring protocols, smart contract-enforced transaction limits and holding periods, secure transaction monitoring database, regulatory reporting channels, and/or immutable compliance audit trails.

According to embodiments, the asset management system includes the KYC module configured to validate and monitor participant identities and ownership structures. According to embodiments, the KYC module implements a KYC protocol that addresses the beneficial ownership verification issue through the use or execution of one or more of multi-layer identity verification systems, enhanced due diligence protocols, real-time customer risk scoring, blockchain-based identity verification, secure customer data management, and/or immutable verification records.

According to embodiments, the asset management system integrates the AML protocol and the KYC protocol to establish a unified compliance framework that performs one or more of the following: validates complex ownership structures through multi-layer verification, monitors transaction patterns specific to tokenized natural resource assets, maintains regulatory compliance across multiple jurisdictions, links physical asset verification with digital transaction monitoring, and/or provides immutable audit trails for all compliance activities.

### Blockchain and Related Terms

"artifact" means a self-contained piece of digital content that can be referenced and updated throughout a blockchain system.

"blockchain" refers to a distributed, immutable ledger that records transactions across a network of computers.

"consensus mechanism" refers to the protocol by which the network reaches agreement on the valid state of the blockchain.

"deep web network address" means a network location that cannot be indexed by web search engines.

"distributed ledger" means a consensus of replicated, shared, and synchronized digital data.

"hash" means a function that converts an input of data into a fixed-size string of text.

"mining" means validating and adding new transactions to the blockchain through computation.

"network interface" means a software or hardware interface between network sections.

"node" refers to a computer or device that participates in the blockchain network.

"permissioned blockchain" means a blockchain where only selected participants can validate.

"private key" means a secret number that allows cryptocurrency transactions to be signed.

"public key" refers to a cryptographic code that allows users to receive cryptocurrency transactions.

"smart contract" means self-executing contracts written into code on the blockchain.

"token" means a digital asset created and managed on the blockchain.

"transaction wallet" means a temporary digital wallet created for a specific transaction.

"user wallet address" means an alphanumeric code for receiving and transmitting transactions.

"wallet" refers to software that allows users to store and manage their private keys.

### Gold Deposit and Resource Terms

"assay" refers to testing of metal or ore to determine ingredients and quality.

"core sample" means a cylindrical section of rock obtained by drilling.

"cut-off grade" means the minimum grade of economically mineable mineralization.

"grade" means the concentration of gold within the ore.

"geophysical survey" means using physical methods to measure rock properties.

"metallurgical recovery" means the percentage of gold extractable from ore.

"NI 43-101" refers to Canadian standards for reporting mineral properties.

"physical mining" means extraction and processing of mineral resources.

"probable reserves" means the economically mineable part of an Indicated Resource

"proven reserves" means the economically mineable part of a Measured Resource

"qualified person" means a professional credentialed to validate resource estimates.

"resource classification" means systematic categorization of mineral resources.

"resource estimate" means professional assessment of deposit quantity and grade.

"resource verification documentation" means official validation of mineral resources.

"S-K 1300" means the SEC's mining property disclosure requirements.

"strike length" means the longest horizontal dimension of an ore body.

"unmined gold deposit" means a natural concentration of gold-bearing material.

### Environmental, Social, and Governance (ESG) Terms

### Environmental Terms

"biodiversity impact" means the effect on local flora and fauna.

"carbon footprint" means total greenhouse gas emissions from mining activities.

"environmental baseline" means initial environmental conditions.

"environmental preservation requirements" means obligations to maintain environments.

"environmental risk assessment" means evaluation of potential impacts.

"preservation value" means ecological worth of maintaining natural state.

"water management" means strategies for protecting water resources.

### Social Terms

"community development agreement" means formal agreements with local communities.

"community impact" means effect on local communities and indigenous peoples.

"cultural heritage" means archaeological, historical, or cultural significance.

"indigenous rights" means rights of indigenous peoples regarding land.

"social license" means level of acceptance by local communities.

"stakeholder engagement" means process of involving relevant parties.

### Governance Terms

"Environmental, Social, and Governance (ESG) compliance" means adherence to environmental, social, and governance standards.

"ESG crediting system" means system for tracking ESG compliance.

"ESG reporting standards" means frameworks for ESG disclosure.

"regulatory oversight" means governance structure ensuring compliance.

"resource verification systems" means technologies for validating resources.

"stakeholder rights" means established rights of interested parties.

"Sustainable Development Goals" means the UN's global goals.

"Transparency Framework" means system for reporting ESG information.

### Digital ESG Integration Terms

"digital signature authorization" means cryptographic validation of rights transfer.

"ESG smart contract" means blockchain contracts encoding ESG requirements.

"ESG token attributes" means ESG characteristics embedded in tokens.

"impact verification oracle" means third-party ESG compliance data sources.

"real-time operational monitoring" means continuous tracking of metrics.

"sustainability metrics" means quantifiable ESG indicators.

"token burning protocol" means process for removing tokens from circulation.

### BRIEF DESCRIPTION OF THE FIGURES

To easily identify the discussion of any particular element or act, the most significant digit or digits in a reference number refer to the figure number in which that element is first introduced.

FIG. 1A is an example network diagram showing technical infrastructure of a networked computing environment supporting an asset management system for the tokenization and trading of partially-mined and unmined gold deposit rights, including application servers, web interfaces, and database systems, according to one or more embodiments.

FIG. 1B is a flow chart illustrating an example process for tokenizing verified unmined gold deposits, according to one or more embodiments.

FIG. 2A depicts a flow chart illustrating an example process for managing anti-money laundering (AML) compliance relating to tokenizing verified unmined gold deposits, according to one or more embodiments.

FIG. 2B depicts a flow chart illustrating an example process for managing know-your-customer (KYC) compliance relating to tokenizing verified unmined gold deposits, according to one or more embodiments.

FIG. 3 is a flow chart showing an example process for secure transfer of blockchain tokens representing interests in unmined gold deposits, including steps for displaying deposit information, receiving exchange orders, and processing token transfers, according to one or more embodiments.

FIG. 4 is a flow chart depicting an example process for calculating and displaying token quantities corresponding to cryptographic currency values based on exchange rates for unmined gold deposit tokens, according to one or more embodiments.

FIG. 5 is a flow chart illustrating an example process for converting specified quantities of blockchain tokens representing unmined gold deposits into corresponding cryptographic currency values using current exchange rates, according to one or more embodiments.

FIG. 6 is a flow chart showing an example process for executing secure exchanges between cryptographic currency and blockchain tokens representing unmined gold deposits through deep web transaction mechanisms, according to one or more embodiments.

FIG. 7 is a flow chart depicting an example process for obtaining and managing access rights to unmined gold deposits through token-based smart contracts, including steps for identity verification and environmental compliance, according to one or more embodiments.

FIG. 8 is an architectural diagram illustrating an example distributed electronic ledger system incorporating multiple validation nodes and consensus mechanisms for maintaining the integrity of unmined gold deposit token transactions, according to one or more embodiments.

FIG. 9 is a flow chart depicting an example process for implementing anti-money laundering compliance associated with tokenizing verified unmined gold deposits, according to one or more embodiments.

FIG. 10 is a diagram illustrating example components and architecture of a computing system implementing the tokenization and trading functionality, including processors, memory systems, and input/output (I/O) components, according to one or more embodiments.

### DETAILED DESCRIPTION

The disclosed technology encompasses blockchain systems, distributed ledger methodologies, and/or computer program commodities at varying degrees of technical integration (herein referred to as an “asset management system”). According to embodiments, the asset management system may include a machine-readable storage medium (or multiple mediums) storing machine-executable instructions that are executable by one or more processing devices to execute components of the specified blockchain technology (e.g., smart contracts, token creation, and distributed consensus mechanisms) to perform operations as described in detail herein.

Aspects of the present disclosure are related to a computer-implemented system (the asset management system) for tokenizing verified assets (e.g., partially-mined and unmined gold deposits) by transforming physical asset documentation into standardized blockchain-based digital tokens. According to embodiments, the asset management system employs machine learning models and automated processing algorithms to validate proof of title, verify resource documentation compliant with regulatory standards (e.g., NI 43-101 and/or S-K 1300), and calculate distributable token quantities based on geological data and risk assessment factors. Through smart contract generation and distributed ledger technology, the asset management system creates fungible digital tokens that represent fractional interests in verified gold deposits, with each token incorporating standardized unit values and embedded contractual terms for secure transfer and ownership management. The asset management system addresses technical challenges in digital asset representation by providing automated, scalable processes that ensure regulatory compliance, maintain data integrity through cryptographic validation, and enable secure trading of unmined mineral asset rights in a digital environment.

According to embodiments, the asset management system includes machine-readable medium which is a physical entity capable of maintaining and storing instructions to be utilized by an instruction execution apparatus, including blockchain nodes, mining equipment, and validation systems. The medium could be, for example, but not restricted to, electronic, magnetic, optical, electromagnetic, semiconductor storage devices, or a fusion of these. A non-limiting list of specific instances of the machine-readable medium includes portable computer diskettes, hard drives, RAM, ROM, EPROM or Flash memory, SRAM, CD-ROMs, DVDs, memory sticks, floppy disks, and mechanical devices like punch-cards or tangible structures with instructions. It should be clarified that the aforementioned medium does not consider transitory signals in isolation, like free-propagating electromagnetic waves or electrical signals over wires.

The machine-executable instructions detailed can be transferred to diverse computational devices, including blockchain nodes and mining systems, from the machine-readable medium or an external computer or storage via networks like the Internet, LANs, WANs, or wireless networks. Such networks may integrate copper or optical fibers, wireless transmission mechanisms, routers, firewalls, switches, gateway computers, and edge servers. Within each computational device, a network interface or adapter fetches the instructions from the network, forwarding them for retention in the device's machine-readable medium and blockchain ledger.

Instructions facilitating blockchain operations of this technology might be encoded as smart contracts, consensus algorithms, mining protocols, or code (both source and object) in diverse programming languages. Examples include but aren't restricted to blockchain-specific languages like Solidity, as well as object-oriented languages like Python, Java, C++, and procedural ones like the "C" language. These instructions might operate wholly on a local blockchain node, partly on local and remote nodes, or entirely across the distributed network. Remote nodes can be linked via peer-to-peer networks, inclusive of the Internet via ISPs. In certain cases, specialized mining hardware such as ASICs or GPUs could employ the instructions, utilizing their state data to actualize facets of the blockchain technology.

Aspects of the present disclosure are described herein with reference to flowcharts and block diagrams of methods, systems, and computer program products per its blockchain embodiments. Each block in these can be realized via machine-executable instructions, including smart contracts and consensus mechanisms, executable by an asset management system, according to embodiments of the present disclosure.

According to embodiments, the instructions may be presented to a processor in general-purpose computers, specialized mining computers, or other programmable data apparatuses of the asset management system, to enable execution of the functions and operations denoted in the diagrams. Furthermore, according to embodiments, the instructions may be conserved, maintained, or stored within a distributed ledger directing nodes to operate in a specific fashion. According to embodiments, the instructions could also be loaded onto a blockchain node or mining device to prompt a sequence of tasks producing a blockchain-driven process.

The depicted flowcharts and diagrams exhibit example embodiments of asset tokenization management, related processes or methods, and product architectures and functionalities per the technology's blockchain solution variants. According to embodiments, the processes of the asset management system, may be implemented by specialized blockchain systems designed for those tasks or combinations of hardware and machine instructions.

For the purposes of this application when referencing NI 43-101 (Canadian) and S-K 1300 (US) standards, these are National regulatory standards for reporting mineral resources and reserves.

According to embodiments, the asset management system implements processes including features and operations relating to resource classification including inferred resource classification (e.g., lowest confidence level, based on limited sampling and geological evidence), indicated resource classification (e.g., moderate confidence, supported by adequately spaced sampling and testing), and measured resource classification (e.g., highest confidence, based on detailed and reliable exploration, sampling, and testing.

According to embodiments, the asset management system implements processes including features and operations relating to reserve classification (e.g., associated with economically mineable deposits) including probable reserves (e.g., reserves derived from indicated and/or measured resources) and proven reserves (e.g., derived from measured resources only).

According to embodiments, the asset management system is configured to implement one or more valuation methods to generate valuations for resources and reserves which integrates multiple components or factors to determine the economic value of mineral deposits. According to embodiments, resource confidence levels serve as the basis for valuation, with each resource classification type or level receiving a specific risk-adjusted multiplier to reflect one or more aspects or parameters, such as, for example, geological certainty. In an embodiment, one or more economic parameters may be employed in generating the valuation. In an embodiment, the economic parameters may include or incorporate commodity price forecasts spanning the projected mine life, alongside access ease, operating costs and capital expenditure requirements for development and sustaining operations, etc.

According to embodiments, the valuation may include one or more technical factors. In an embodiment, the technical factors may include or consider one or more of metallurgical recovery rates based on test work, mining dilution derived from geotechnical studies, and processing costs determined through engineering studies. In an embodiment, the valuation may include jurisdictional considerations such as the evaluation of royalty structures, taxation regimes, and permitting timeline impacts on project economics. In an embodiment, the valuation may include market comparable analysis which examines similar deposits in terms of one or more factors including grade, tonnage, jurisdiction, etc. to validate valuations against transaction data.

According to embodiments, the valuation calculation method may include verification of base resource and reserve tonnages and grades through qualified person review. In an embodiment, the valuation calculation method may include the consideration of technical modifying factors that are applied to account for one or more factors such as mining recovery, dilution, processing performance, etc. According to embodiments, the valuation calculation method may include an estimation of operating and capital costs, incorporating one or more capital-related costs relating to equipment, labor, consumables, infrastructure requirements, etc. According to embodiments, the valuation calculation method may include revenue projections that are developed using commodity price forecasts that consider market cyclicality and trends. In an embodiment, the valuation calculation method may include risk-adjusted net present value calculations that incorporate discount rates reflecting project stage and jurisdiction. In an embodiment, the valuation calculation method may incorporate a comparable transaction analysis to validate the calculated valuations against market precedents.

According to embodiments, the valuation calculation method may include resource and reserve valuations which undergo periodic updates to maintain accuracy and market relevance. According to embodiments, the valuation calculation method may include the use of technical reports and resource estimates that are updated to reflect new drilling, sampling, and geological interpretation. According to embodiments, the valuation calculation method may include commodity price forecasts that are revised based on market conditions and industry consensus. According to embodiments, the valuation calculation method may include market transactions that are analyzed to validate valuation parameters. According to embodiments, the valuation calculation method may include operating cost assumptions that are adjusted for inflation, technological changes, and efficiency improvements. According to embodiments, the valuation calculation method may include the consideration of jurisdictional factors that may be reassessed as regulatory and fiscal regimes change, update, and/or evolve. According to embodiments, the valuation calculation method may include updates that are validated by one or more qualified persons before being reflected in token smart contracts through, for example, oracle-based price feeds.

According to embodiments, the token architecture may be implemented by the asset management system through a series of smart contracts deployed on an enterprise-grade blockchain platform. According to embodiments, these contracts encode the relationship between physical claims and digital tokens, incorporating resource documentation further comprising the use of smart contracts that reference authenticated NI 43-101 or S-K 1300 technical reports, storing claim coordinates and resource estimates on-chain. According to embodiments, these resources are updatable by authorized qualified persons through protocols that confirm the authenticity of the qualified persons. According to embodiments, implementation of on-chain know-your-customer (KYC) and anti-money laundering (AML) verification may be managed through integration with established compliance providers.

According to embodiments, the asset management system is configured to implement a smart contract architecture that includes one or more modules for handling active mining operations, including, for example, token adjustment mechanisms based on verified production data and real-time reconciliation with geological models. According to embodiments, the smart contracts may implement standardized interfaces for receiving and validating production data from multiple mining operations simultaneously or concurrently (e.g., multiple mining data systems).

According to embodiments, the asset management system can be configured to employ a tokenized warehouse receipt form or format which represents a standardized digital format of a traditional warehouse receipt, adapted specifically for unmined gold deposits. Similar to how agricultural commodities use warehouse receipts under USDA frameworks, tokenized warehouse receipts for unmined gold deposits provide a legally recognized structure for representing ownership rights of verified underground resources while maintaining physical preservation of the deposit.

Advantageously, the use of digital receipts operate under established legal frameworks, particularly Uniform Commercial Code (UCC) Article 7, which governs documents of title including warehouse receipts. According to embodiments, the adaptation of this traditional structure to blockchain technology maintains the legal certainty of warehouse receipts while adding the benefits of digital transfer and tracking. A tokenized warehouse receipt directly represents a specific quantity of verified gold resources through a standardized format compliant with state warehouse receipt requirements, establishing clear chain of title and ownership rights while integrating with existing commodity trading frameworks. According to embodiments, this structure effectively separates the receipt from corporate entity ownership while maintaining compliance with state-level commodity warehouse regulations.

According to embodiments, the warehouse receipt framework employed by the asset management system provides the foundation for subsequent blockchain implementation and distributed ledger systems, ensuring that the technical architecture serves and enhances established legal structures rather than attempting to replace them. According to embodiments, the asset management system provides for the integration of traditional warehouse receipt concepts with modern blockchain technology to create a methodology for representing and trading unmined gold deposit rights while maintaining regulatory compliance and market accessibility.

According to embodiments, the asset management system can be operatively coupled with one or more operational management and monitoring systems to enable real-time operational monitoring through integration with token mining operations software via one or more secure application programming interface (API) connections.

According to embodiments, the asset management system can be employed to process ESG credits and compliance via an integration with one or more ESG crediting systems with the smart contract infrastructure to track metrics (e.g., issue metrics) against permitted thresholds.

According to embodiments, the asset management system includes a regulatory reporting system configured to maintain an immutable audit trail of all compliance-related events and checks (e.g., related to KYC and AML compliance). For example, the regulatory reporting system is configured to generate regulatory reports in standardized formats required by different jurisdictions, with capabilities to adapt to new reporting requirements through modular smart contract updates. According to embodiments, the regulatory reporting system tracks metrics including transaction volumes, holder distributions, and compliance verification timestamps.

According to embodiments, the asset management system performs operations relating to token burning. According to embodiments, as real world deposits are transformed from unmined to active mining, the asset management system manages the reduction of tokens associated with those real-world assets through a token burning protocol. According to embodiments, real world/real time mining data from operational owners is cross-referenced with assay results and independently verified by appointed auditors. In an embodiment, the data engages the committed smart contracts and may require multi-signature validation and confirmation from operational, technical, and compliance stakeholders before executing token burns. In an embodiment, the token burn may including one or more of the following operations: a) Mining data is collected and hashed on-chain, b) a qualified person validates extraction data, c) an independent auditor verify compliance, d) smart contracts include checks for required signatures and a token burn amount is calculated based on verified extraction. According to embodiments, the safety protocols for token burns may also include: a) rate limiting to prevent excessive burns, b) emergency pause functionality, c) minimum time-locks between burns, d) maximum burn amounts per session, and e) multi-signature approval for large burns. In an embodiment, the token burn protocol includes a recovery mechanism in case of operational errors or legal proceedings requirements.

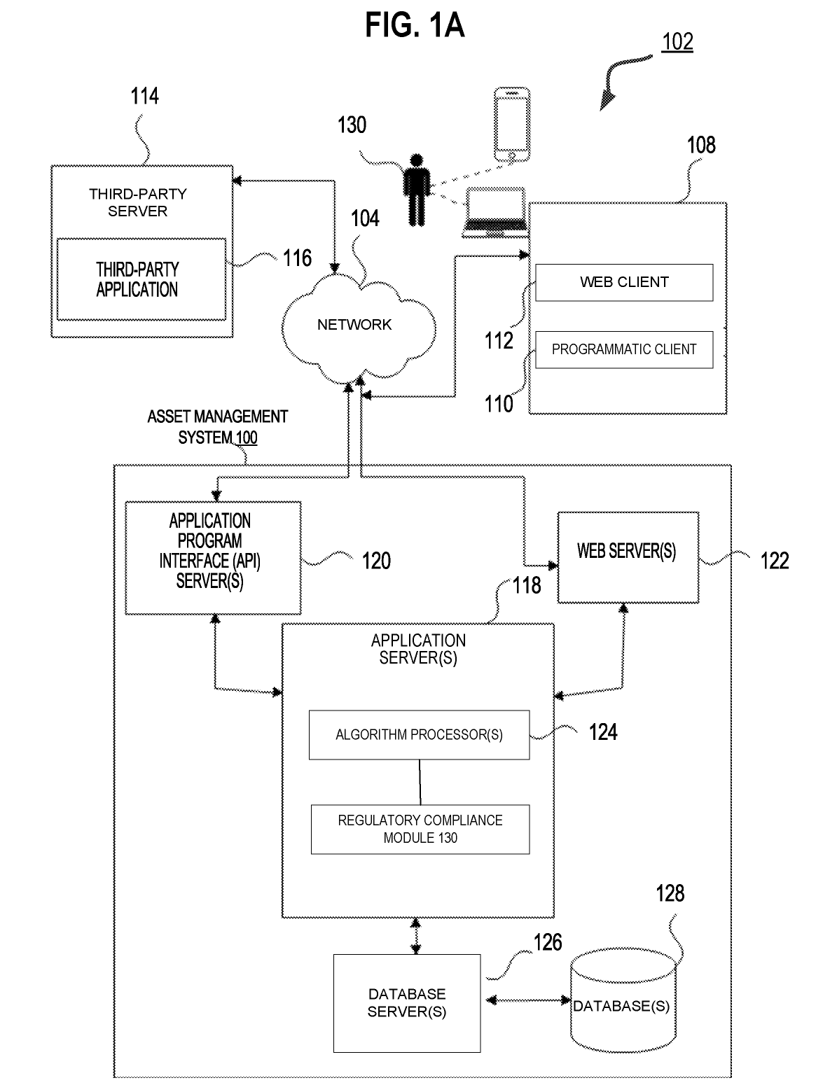

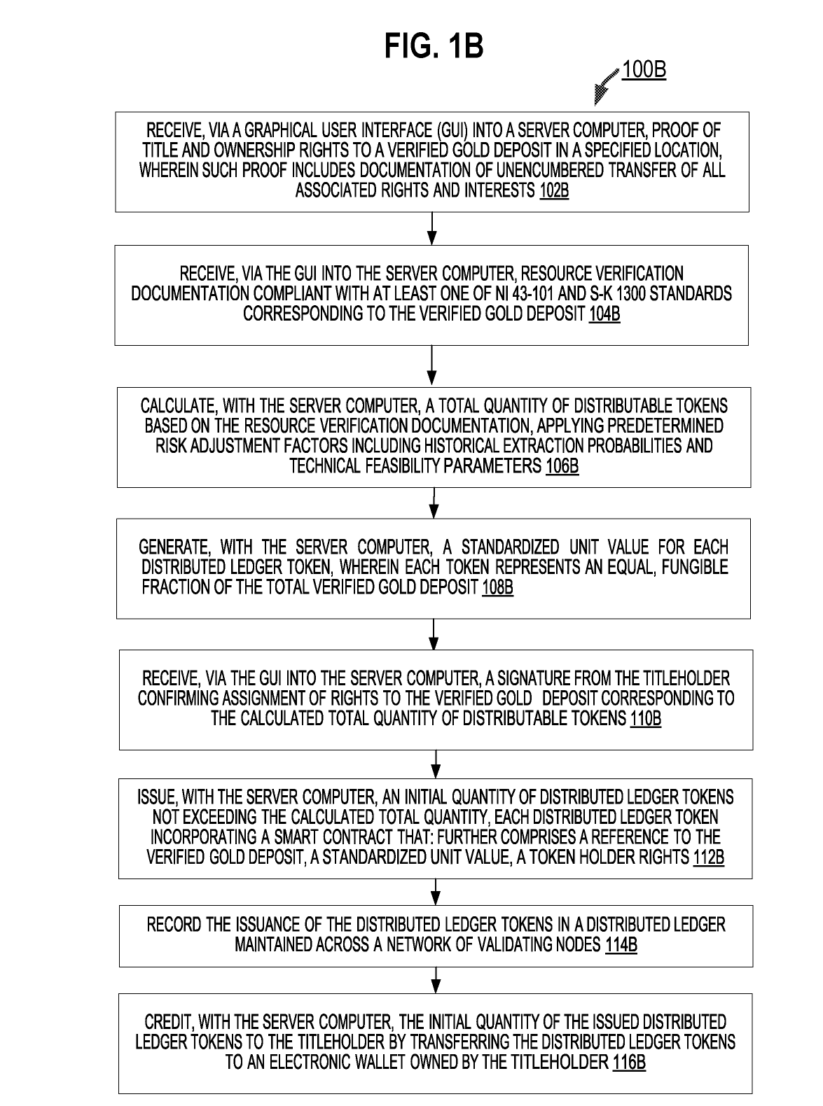

FIG. 1A is a diagrammatic representation of a networked computing environment 102 including an asset management system 100, in accordance with embodiments of the present disclosure. According to embodiments, the asset management system 100 may include one or more computing devices (e.g., application servers such as application server 118) configured to server-side functionality via a network 104 to a networked user device, in the form of a client device 108 that is accessed by a user 130. In an embodiment, a web client 112 (e.g., a browser) and a programmatic client 110 (e.g., an application or “app”) are hosted and executed on the web client 112.

According to embodiments, an application program interface (API) server 120 and a web server 122 provide respective programmatic and web interfaces to the asset management system 100. In an embodiment, the asset management system 100 includes an application server 118 configured to host one or more processing devices (e.g., algorithm processor 124) which includes components, modules and/or applications configured to perform operations, functions, and steps as described in detail with reference to FIGS. 1B-10.

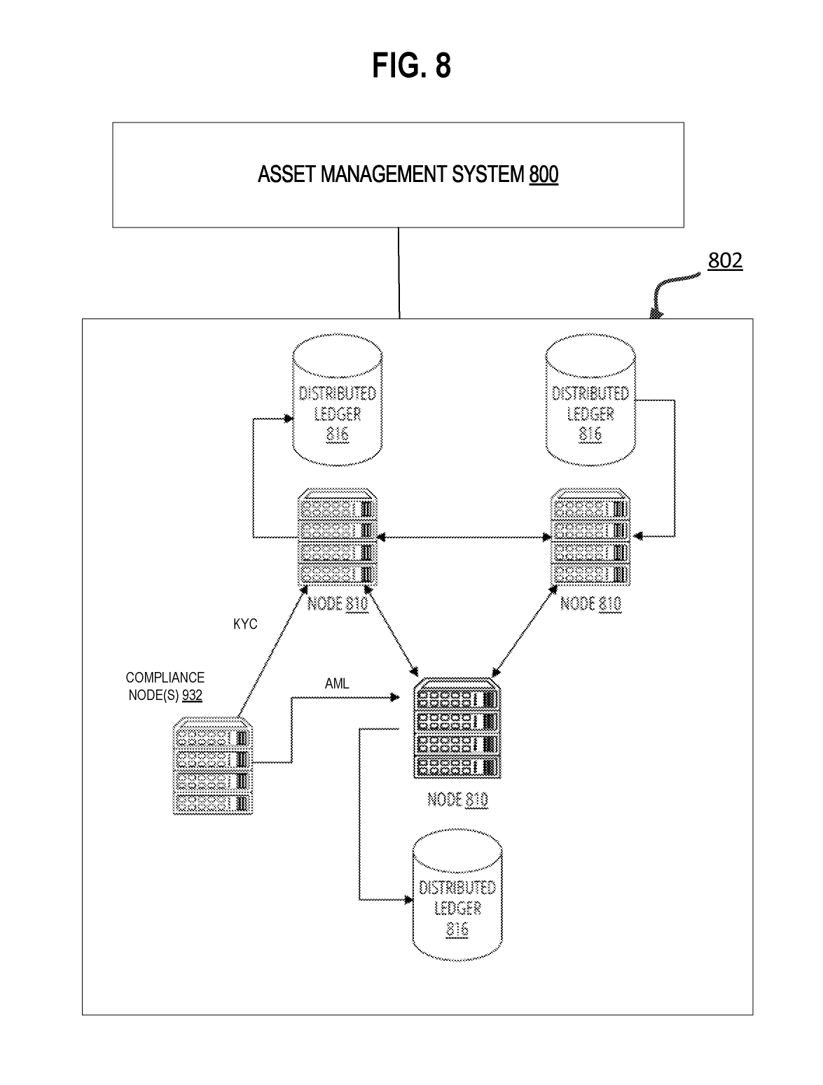

According to embodiments, the web client 112 communicates with the asset management system 100 (e.g., algorithm processor 124 of the asset management system 100) via the web interface supported by the web server 120. In an embodiment, the programmatic client 110 communicates with the asset management system 100 (e.g., algorithm processor 124 of the asset management system 100) via a programmatic interface provided by an API application on the API server 120. The third-party application 816 may, for example, be a distributed ledger (e.g., distributed ledger 816 of FIG. 8) or a node (e.g., node 810 of FIG. 8) of a third party system configured to register tokens related to unmined gold deposits.

According to embodiments, the one or more application servers 118 of the asset management system 100 are communicatively coupled to one or more database servers 126 that facilitate access to an information storage repository or one or more databases 128. In an example embodiment, the databases 128 may include storage devices that store information to be published and/or processed by the one or more algorithm processors 124 of the asset management system 100.

In an embodiment, a third-party application 116 executing on a third-party server 114, is shown as having programmatic access to the one or more applications servers 118 of the asset management system 100 via the programmatic interface provided by the one or more API server 120. In an embodiment, the third-party application 116 executing on a third-party server 114, is shown as having programmatic access to a user interface (e.g., an environmental considerations user interface) corresponding to an API server 120 of the asset management system 100. According to embodiments, the third-party application 116, using information retrieved from the application server 118, may support one or more features or functions on a website hosted by the third party.

According to embodiments, the asset management system 100 may include one or more modules configured to perform the operations and functions of the methods and processes described in detail below with reference to FIGS. 1B-10. According to embodiments, the asset management system 100 may include a specialized computing architecture that transforms physical asset documentation into standardized digital representations through a series of technically integrated processes. In an embodiments, the asset management system 100 includes one or more computing devices (e.g., servers) having one or more processors (e.g., algorithm processors 124 of FIG. 1A) configured to execute machine-readable instructions stored in non-transitory computer memory, wherein the instructions cause the processors to perform specific technological operations that solve technical problems in digital asset representation and verification.

According to embodiments, the asset management system 100 incorporates a document processing subsystem that receives and validates proof of title documentation through automated parsing algorithms. The asset management system 100 may employ optical character recognition (OCR) technology combined with natural language processing models to extract and verify ownership information from scanned documents. According to embodiments, the asset management system 100 may execute one or more machine learning models including machine learning classifiers trained to identify specific document types and validate completeness of ownership transfer documentation, reducing manual verification overhead and improving accuracy of title validation processes.

According to embodiments, the asset management system 100 may include a resource verification module configured to process technical documentation compliant with regulatory standards (e.g., NI 43-101 and S-K 1300). In an embodiment, the resource verification module may implement one or more pattern recognition algorithms to identify qualified person signatures, extract resource estimate data, and validate geological survey information. According to embodiments, the asset management system 100 (e.g., the resource verification module) may implement one or more machine learning models trained on historical resource documentation to identify and flag inconsistencies or missing elements in submitted verification materials, enhancing the reliability of resource validation processes.

According to embodiments, the asset management system 100 is configured to establish and employ one or more secure data connections with one or more mining operation systems 140 associated with any actively mined portions of the at least one gold deposit. According to embodiments, the asset management system 100 communicatively couples with the one or more mining operation systems 140 to enable real-time monitoring of extraction data and production metrics relating to the gold deposit (e.g., mining data relating to the partially-mined deposits and the unmined portion of the deposits).

According to embodiments, the asset management system 100 may include a computational engine that calculates distributable token quantities based on processed resource data. According to embodiments, the computational engine may employ one or more statistical models and risk assessment algorithms that analyze historical extraction probabilities, geological factors, and technical feasibility parameters. In an embodiment, the computational engine of the asset management system 100 may include one or more machine learning regression models trained on mining industry data to predict extraction success rates and adjust token quantities accordingly, providing more accurate representations of underlying asset values.

According to embodiments, the asset management system 100 calculates a total quantity of distributable tokens based on the resource verification documentation and real-time mining data. According to embodiments, in the calculation, the asset management system 100 can apply one or more predetermined risk adjustment factors including historical extraction probabilities, technical feasibility parameters, and verified production rates relating to the active mining operations.

According to embodiments, the asset management system 100 may include a smart contract generation module configured to create standardized digital tokens with embedded contractual terms. According to embodiments, the smart contract generation module may utilize template-based code generation combined with parameter substitution algorithms to produce blockchain-compatible smart contracts. According to embodiments, the smart contract generation module of the asset management system 100 may employ automated testing frameworks to validate smart contract functionality before deployment, ensuring proper execution of token transfer and rights management operations.

According to embodiments, the asset management system 100 may incorporate a distributed ledger interface that records token issuance across multiple validating nodes. In an embodiment, the distributed ledger interface may implement one or more consensus protocol handlers that manage communication with blockchain networks, ensuring proper transaction validation and immutable record keeping. In an embodiment, the asset management system 100 employ cryptographic hashing algorithms to generate unique token identifiers and maintain data integrity throughout the tokenization process.

According to embodiments, the asset management system 100 may include a wallet management module configured to facilitate electronic wallet operations for token distribution. In an embodiment, the wallet management component may implement multi-signature protocols and secure key management systems to protect token transfers. In an embodiment, the asset management system 100 may employ one or more machine learning anomaly detection models to monitor wallet transactions to identify potentially fraudulent activities, enhancing security of the tokenization platform.

According to embodiments, the asset management system 100 may include a user interface subsystem that provides graphical interfaces for document submission and process monitoring. The user interface subsystem may employ responsive web design frameworks and real-time status update mechanisms to enhance user experience during tokenization operations. In an embodiment, the asset management system 100 may employ one or more machine learning personalization algorithms to adapt interface presentations based on user behavior patterns and preferences.

According to embodiments, the asset management system 100 may include a quality assurance module configured to execute one or more automated validation routines that verify data consistency across processing stages. According to embodiments, the asset management system 100 may include one or more machine learning classification models trained to identify potential errors or inconsistencies in processed documentation, triggering manual review processes when necessary. In an embodiment, the asset management system 100 may implement automated rollback mechanisms to reverse incomplete or erroneous tokenization operations, maintaining data integrity throughout the process.

According to embodiments, the asset management system 100 addresses technical challenges in digital asset creation by providing automated, scalable, and verifiable processes for converting physical asset documentation into blockchain-compatible digital representations. The asset management system 100 integration of machine learning models, cryptographic protocols, and distributed ledger technologies creates a technological solution that improves efficiency, accuracy, and security compared to manual tokenization approaches.

According to embodiments, the asset management system 100 may employ a blockchain including a distributed ledger based on a distributed computing infrastructure that provides immutable record-keeping and cryptographic validation of token transactions through a network of validating nodes, solving the technical problem of establishing verifiable ownership and transferring records for digital asset representations without relying on centralized authorities. According to embodiments, the blockchain implementation employs smart contracts as executable code stored on the distributed ledger that automatically enforce token transfer rules and ownership rights, creating a technological solution that eliminates manual contract enforcement and reduces computational overhead in managing complex multi-party asset transactions.

According to embodiments, the asset management system 100 employs smart contracts for automated compliance and transfer restrictions. According to embodiments, the asset management system 100 provides for integration of regulatory standards (e.g., NI 43-101/S-K 1300) and ESG tracking functionality. In an embodiment, the asset management system 100 employs token burning protocols tied to real-world mining activity and multi-signature validation and deep web transaction mechanisms for security.

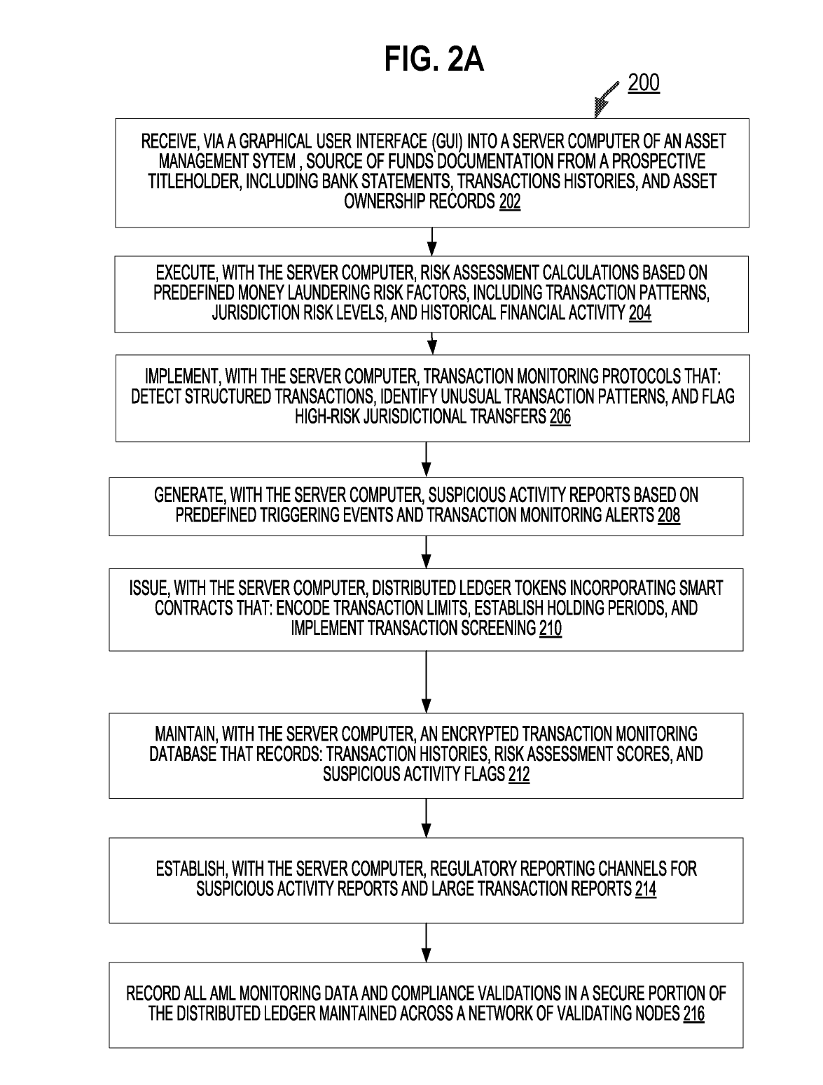

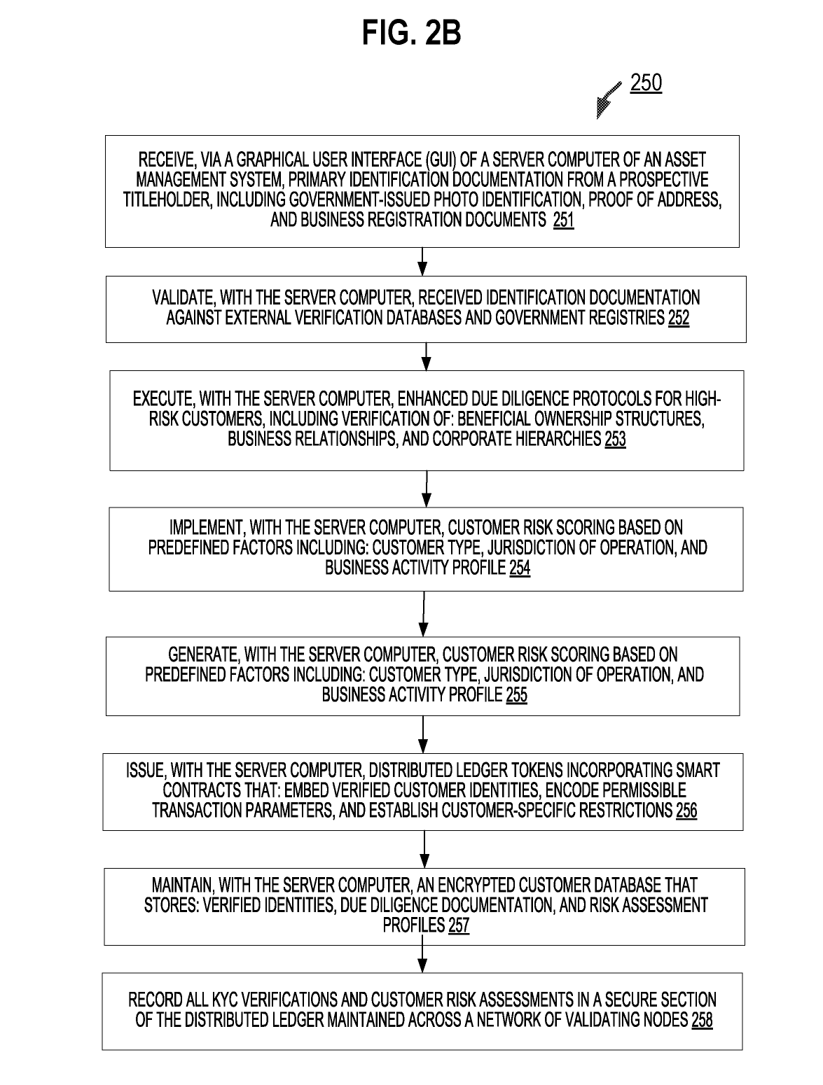

According to embodiments, the asset management system 100 includes a regulatory compliance module 130 configured to implement a regulatory compliance processing layer that operates across all system components. In an embodiment, the regulatory compliance module 130 is configured to execute compliance validation services running on one or more application servers, regulatory data synchronization across network nodes, and real-time compliance status monitoring. According to embodiments, the regulatory compliance module 130 of the asset management system 100 system maintains encrypted compliance data channels between components while preserving necessary regulatory audit trails. According to embodiments, the API servers may include specialized endpoints for regulatory reporting and compliance verification, with capability to adapt to evolving regulatory requirements. According to embodiments, the database architecture incorporates dedicated compliance data structures that maintain regulatory status information while ensuring data privacy and security. According to embodiments, the regulatory compliance module 130 is configured to perform operations relating to AML compliance (e.g., AML compliance process 200 of FIG. 2A and KYC compliance process 250 of FIG. 2B, as described in greater detail below).

FIG. 1B is a flow diagram of an example method 100B executable by an asset management system (e.g., asset management system 100 of FIG. 1A) to tokenize verified unmined gold deposits, according to embodiments of the present disclosure. The method 100B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 102B, the tokenization method 100B receives, via a graphical user interface (GUI) into a server computer, proof of title and ownership rights to a verified gold deposit in a specified location, wherein such proof includes documentation of unencumbered transfer of all associated rights and interests. In step 104B, the tokenization method 100B receives, via the GUI into the server computer, resource verification documentation compliant with one or more standards (e.g., at least one of NI 43-101 and S-K 1300 standards) corresponding to the verified gold deposit. In an embodiment, the resource verification documentation includes one or more of drill data, assay results, or geological models.

In step 106B, the tokenization method 100B calculates (e.g., with a processing device of a server computer) a total quantity of distributable tokens based on the resource verification documentation, applying predetermined risk adjustment factors including historical extraction probabilities and technical feasibility parameters.

In step 108B, the tokenization method 100B generates (e.g., with a processing device of a server computer) a standardized unit value for each distributed ledger token, wherein each token represents an equal, fungible fraction of the total verified gold deposit. In step 110B, the tokenization method 100B receives, via the GUI into the server computer, a signature from the titleholder confirming assignment of rights to the verified gold deposit corresponding to the calculated total quantity of distributable tokens. In step 112B, the tokenization method 100B issues, with the server computer, an initial quantity of distributed ledger tokens not exceeding the calculated total quantity, each distributed ledger token incorporating a smart contract that: further comprises a reference to the verified gold deposit, a standardized unit value, a token holder rights.

In step 114B, the tokenization method 100B records the issuance of the distributed ledger tokens in a distributed ledger maintained across a network of validating nodes. In step 116B, the tokenization method 100B credits, with the server computer, the initial quantity of the issued distributed ledger tokens to the titleholder by transferring the distributed ledger tokens to an electronic wallet owned by the titleholder.

According to embodiments, FIG. 1B illustrates a tokenization method 100B relating to the tokenization of a single gold deposit. According to embodiments, the tokenization method 100B may be executed to tokenize any number of gold deposits. According to embodiments, the tokenization method 100B may be executed to establish a fungible token that represents a fractional value related to a plurality of total unmined gold deposits across a plurality of locations.

FIG. 2A depicts a flow diagram of an example method 200 executable by an asset management system (e.g., regulatory compliance module 130 of asset management system 100 of FIG. 1A) to manage anti-money laundering compliance associated with tokenizing verified unmined gold deposits, according to embodiments of the present disclosure. According to embodiments, the method 200 (also referred to as a “AML compliance method 200”) can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 202, a processing device (e.g., a processing device of a regulatory compliance module 130 of the asset management system 100 of FIG. 1A) receives (e.g., via a graphical user interface (GUI) communicatively coupled to the asset management system) source of funds documentation from a prospective titleholder, including bank statements, transaction histories, and asset ownership records. In step 204, the processing device executes one or more risk assessment calculations based on one or more of: predefined money laundering risk factors, including transaction patterns, jurisdiction risk levels, and historical financial activity.

In step 206, the processing device implements transaction monitoring protocols that include execution of one or more of the following operations: detect structured transactions, identify unusual transaction patterns, and flag high-risk jurisdictional transfers. In step 208, the processing device generates one or more suspicious activity reports based on predefined triggering events and transaction monitoring alerts.

In step 210, the processing device issues distributed ledger tokens incorporating smart contracts that: encode transaction limits, establish holding periods, and implement transaction screening. In step 212, the processing device maintains an encrypted transaction monitoring database that records one or more of the following: transaction histories, risk assessment scores, and suspicious activity flags. In Step 214, the processing device establishes one or more regulatory reporting channels for suspicious activity reports and large transaction reports. In Step 216, the processing device records a set of AML monitoring data and compliance validations in a secure section of the distributed ledger maintained across a network of validating nodes.

FIG. 2B depicts a flow diagram of an example method 250 executable by an asset management system (e.g., regulatory compliance module 130 of asset management system 100 of FIG. 1A) to manage know-your-customer (KYC) compliance associated with tokenizing verified unmined gold deposits, according to embodiments of the present disclosure. According to embodiments, the method 200 (also referred to as a “KYC compliance method 250”) can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 251, a processing device (e.g., a processing device of a regulatory compliance module 130 of the asset management system 100 of FIG. 1A) receives (e.g., via a graphical user interface (GUI) communicatively coupled to the asset management system) primary identification documentation from a prospective titleholder, including, for example, government-issued photo identification, proof of address, and/or business registration documents.

In step 252, the processing device validates received identification documentation against external verification databases and government registries.

In step 253, the processing device executes enhanced due diligence protocols for high-risk customers, including verification of: beneficial ownership structures, business relationships, and corporate hierarchies.

In step 254, the processing device implements customer risk scoring based on predefined factors including: customer type, jurisdiction of operation, and business activity profile.

In step 255, the processing device generates a KYC verification report documenting the completed identity checks and associated risk assessments.

In step 256, the processing device issues distributed ledger tokens incorporating smart contracts that: embed verified customer identities, encode permissible transaction parameters, and establish customer-specific restrictions.

In step 257, the processing device maintains an encrypted customer database that stores: verified identities, due diligence documentation, and risk assessment profiles.

In step 258, the processing device records a set of one or more KYC verifications and customer risk assessments in a secure section of the distributed ledger maintained across a network of validating nodes.

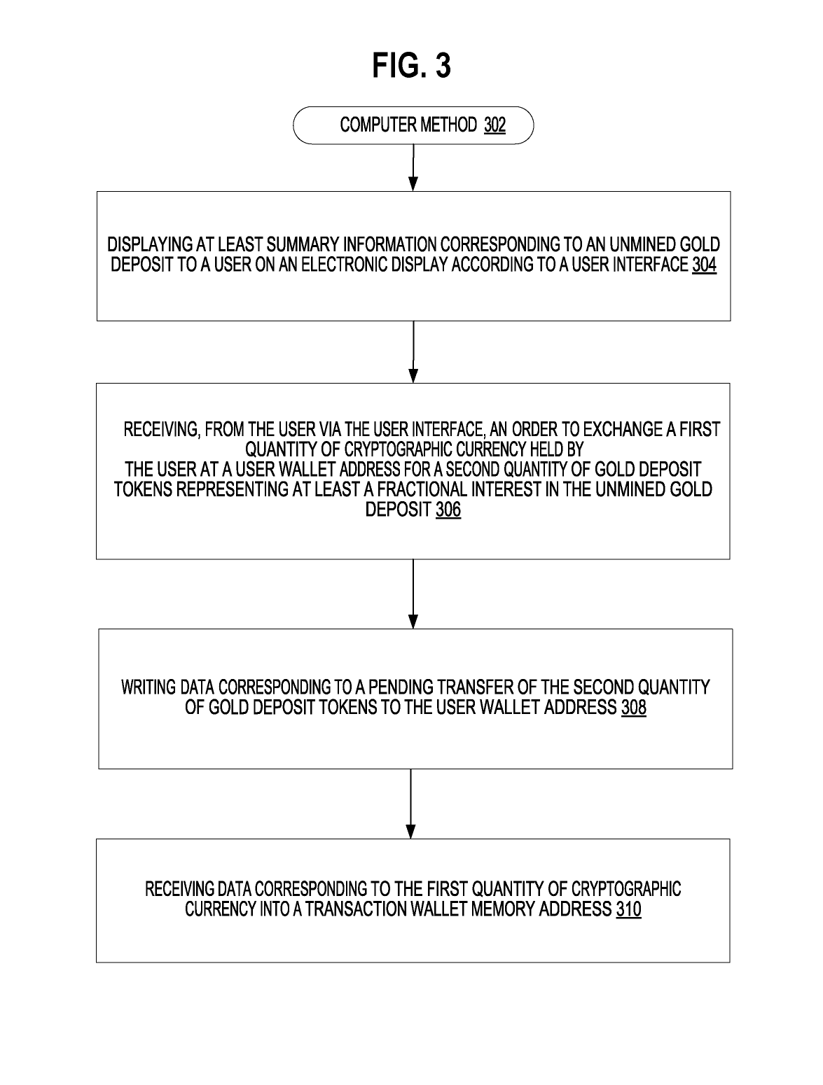

FIG. 3 is a flow chart showing a method 302 executable by an asset management system (e.g., asset management system 100 of FIG. 1A) for secure transfer of a blockchain token representing an interest in an unmined gold deposit, according to embodiments of the present disclosure.

In step 304, a processing device (e.g., a processing device of the asset management system 100 of FIG. 1A) displays at least summary information corresponding to an unmined gold deposit to a user on an electronic display according to a user interface. According to embodiments, the summary information corresponding to the unmined gold deposit, as used here and as referenced throughout this disclosure, may include one or more of an identifier, a description, a country where the deposit is located, current and/or prior owner information, identification of geological surveys conducted, one or more resource estimates compliant with one or more standards (e.g., NI 43-101 or S-K 1300 standards), one or more dates related to claim validity and/or expiration, geological surveys related to the gold deposit, and/or an identifier of related gold deposits. According to embodiments, the summary information includes tokenization information such as current token holder(s), types and/or terms of ownership, and/or availability of tokens. According to embodiments, the summary information may identify a type of the gold deposit, e.g., placer, lode, proven reserves, probable reserves, or the like, a pending resource verification, and/or geological assessment. According to embodiments, the summary information may identify a chain of title in the gold deposit.

According to embodiments, in step 306, the processing device receives, from the user via the user interface, an order to exchange a first quantity of cryptographic currency held by the user at a user wallet address for a second quantity of gold deposit tokens representing at least a fractional interest in the unmined gold deposit. According to embodiments, the term "user wallet address" may include a data string, such as an alphanumeric code, that is generated to receive transactions and transmit transactions. In an embodiment, the user wallet address may be generated from a public key. The public key is derivable from a private key known to a party having ownership of the wallet (or alternatively, from a private key that is held in custody of the wallet), but the private key cannot be derived from the public key, owing to use of a hyperbolic function that is a "one-way" function. The contents (and authority for transferring the contents) of a wallet address are accessible by the party holding the private key.

According to embodiments, at step 308, the processing device writes data corresponding to a pending transfer of the second quantity of gold deposit tokens to the user wallet address. According to embodiments, in step 310, the processing device receives data corresponding to the first quantity of cryptographic currency into a transaction wallet memory address.

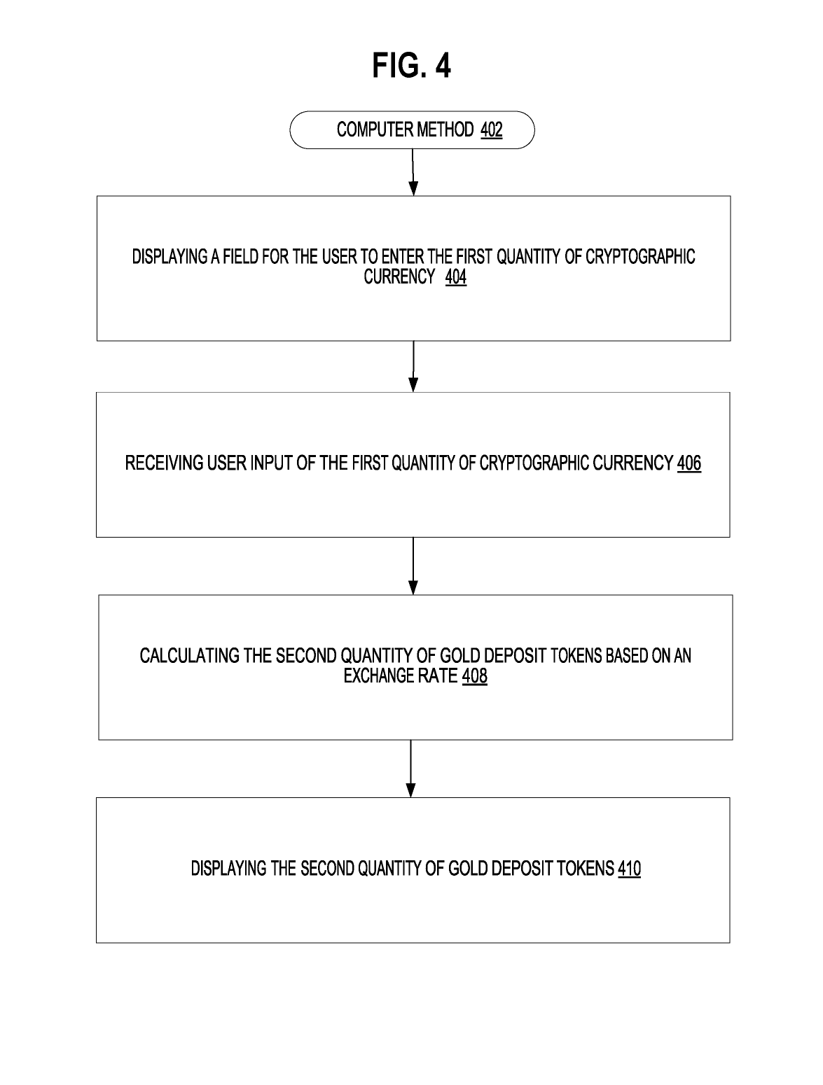

FIG. 4 is a flow chart illustrating a method 402 executable by an asset management system (e.g., asset management system 100 of FIG. 1A) for displaying a quantity of blockchain tokens representing an unmined gold deposit corresponding to a selected amount of a cryptographic currency as a function of an exchange rate, according to one or more embodiments.

In step 404, a processing device (e.g., a processing device of the asset management system 100 of FIG. 1A) displays a field for the user to enter the first quantity of cryptographic currency. In step 406, the processing device receives user input of the first quantity of cryptographic currency. In step 408, the processing device calculates the second quantity of gold deposit tokens based on an exchange rate. In an embodiment, in step 408, the processing device further calculates the exchange rate based on relative supply and demand of the cryptographic currency and the gold deposit tokens. In an embodiment, the processing device calculates the exchange rate based on a supply and demand of the cryptographic currency and a specified price of the gold deposit tokens. In step 410, the processing device displays the second quantity of gold deposit tokens.

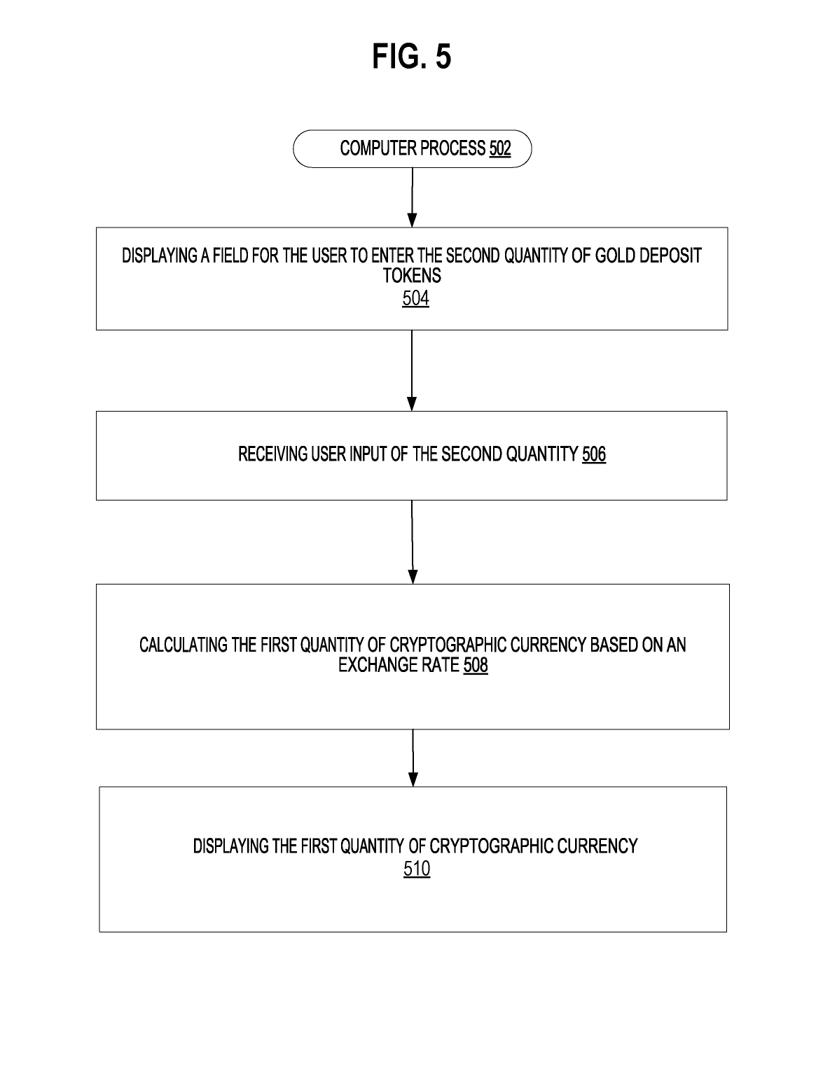

FIG. 5 is a flow chart illustrating a method 502 executable by an asset management system (e.g., asset management system 100 of FIG. 1A) for displaying a quantity of a cryptographic currency corresponding to a selected amount of blockchain tokens representing an unmined gold deposit as a function of an exchange rate, according to one or more embodiments. According to embodiments, the method 502 may be performed as part of the displaying of at least summary information about the unmined gold deposit from step 304 of FIG. 3.

In step 504, a processing device (e.g., a processing device of the asset management system 100 of FIG. 1A) displays a field for the user to enter the second quantity of gold deposit tokens. In step 506, the processing device receives user input of the second quantity. In step 508, the processing device calculates the first quantity of cryptographic currency based on an exchange rate. In step 510, the processing device displays the first quantity of cryptographic currency.

According to embodiments, method 502 is executed by a cryptographic currency display system that is configured to implement a regulatory compliance overlay that shows jurisdiction-specific requirements and restrictions relating to regulatory compliance (e.g., AML compliance, KYC compliance, etc.). According to embodiments, the regulatory compliance overlay includes one or more visual indicators relating to compliance status, permitted trading volumes, and applicable regulatory restrictions. According to embodiments, the exchange rate calculations incorporate compliance-based adjustments reflecting regulatory requirements in different jurisdictions. According to embodiments, the cryptographic currency display system of the asset management system maintains real-time compliance monitoring that affects display parameters based on user jurisdiction and regulatory status, with updates reflecting changes in compliance requirements.

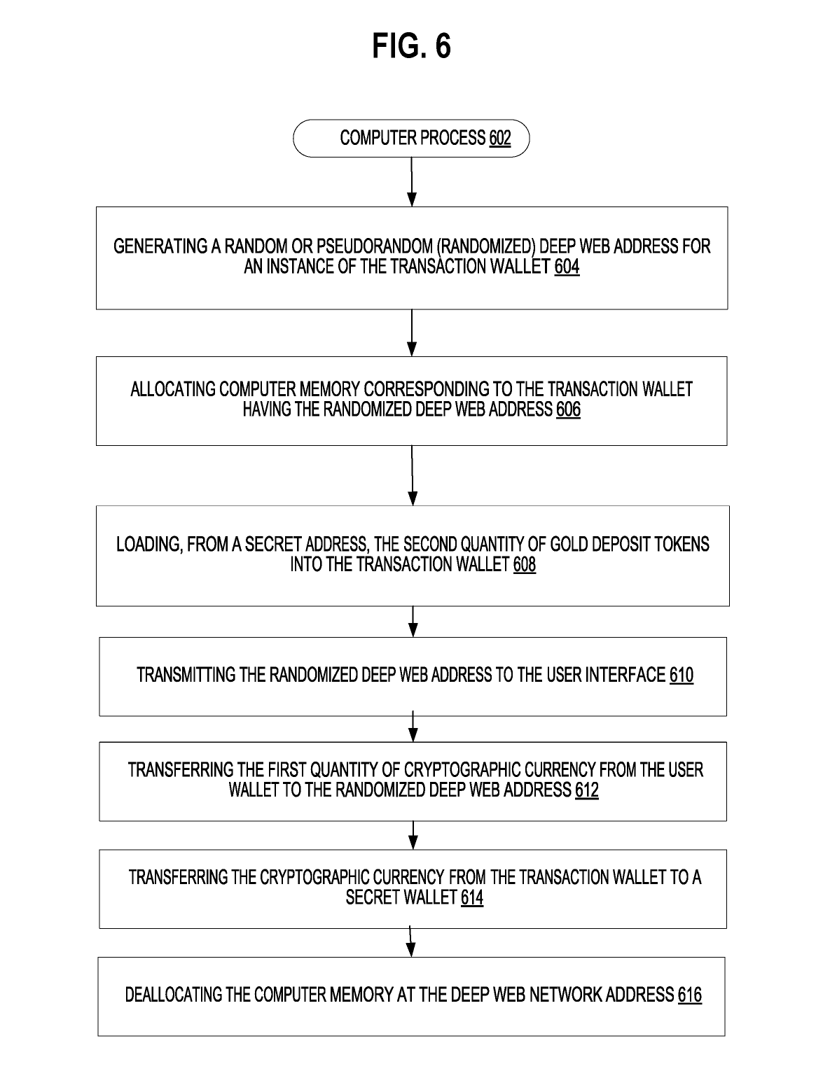

FIG. 6 is a flow chart illustrating a method 602 executable by an asset management system (e.g., asset management system 100 of FIG. 1A) for exchanging a cryptographic currency for blockchain tokens representing an unmined gold deposit, according to one or more embodiments. According to embodiments, method 602 may be performed as part of the display of at least summary information about the unmined gold deposit from step 304 of FIG. 3, where step 304 includes displaying a field for the user to enter a committed bid price of the gold deposit tokens. According to embodiment, method 602 may be performed as part of the receiving of the order to exchange the first quantity of cryptographic currency for the second quantity of gold deposit tokens from step 306 of FIG. 3, wherein step 306 further includes receiving the committed bid price. In an embodiment, the smart contract may include the commitment to sell at least a portion of the gold deposit tokens at the committed bid price. In an embodiment, additionally, or alternatively, displaying at least summary information about an unmined gold deposit from step 304 of FIG. 3 may include displaying a committed selling price. In an embodiment, the smart contract includes the commitment to sell at least a portion of the gold deposit tokens at the committed selling price.

With reference to FIG. 6, in step 604, the processing device generates a random or pseudorandom (e.g., randomized) deep web address for an instance of a transaction wallet. For example, step 604 may include generating a new public key not previously associated with a blockchain transaction or generating a new private key and deriving a new public key from the new private key not previously associated with a blockchain transaction.

In step 606, the processing device allocates computer memory corresponding to the transaction wallet having the randomized deep web address (e.g., a deep web network address). In step 608, the processing device loads (e.g., retrieves, receives, collects, etc.), from a secret address, the second quantity of gold deposit tokens into the transaction wallet. In step 610, the processing device transmits the randomized deep web address (e.g., the deep web network address) to the user interface. In an embodiment, a deep web network address includes a first portion that is indexed by and/or linked from a surface web location accessible by conventional web search engines, and a second portion that is unpredictable and sufficiently long to substantially prevent systematic search. In an embodiment, the deep web network address may thus be non-indexed and non-linked. In an embodiment, the deep web network address may be uncrawlable. According to a solution variant, the deep web network address does not require registration or login. In an alternative solution variant, the deep web network address may be a contextual address, such as an address configured to be accessible to query by devices having a predetermined URL access history. The deep web network address may be generated by a JavaScript or other randomizing or pseudo-randomizing application. According to an embodiment, the deep web network address may include a Uniform Resource Identifier (URI) including a URL that is indexed and, associated with the URL, a non-indexed query including a passcode that is generated by a random number or pseudo-random number generator and which provides a path to the proposal.

In step 612, the processing device transfers (e.g., causes an electronic transfer) the first quantity of cryptographic currency from the user wallet to the randomized deep web network address. In step 614, the processing device transfers the cryptographic currency from the transaction wallet to a secret wallet. In step 616, the processing device deallocates the computer memory at the deep web network address.

According to one or more embodiments, the cryptographic currency includes value carried by a public blockchain. Additionally or alternatively, the cryptographic currency includes at least one transaction history verifiable by the public blockchain. In an embodiment, the cryptographic currency includes fungible value. In an embodiment, the cryptographic currency includes at least one transaction history carried by a permissioned blockchain.

According to embodiments, the method 602 includes implementation of a regulatory change management protocol that enables rapid adaptation to evolving compliance requirements. According to embodiments, the method 602 .includes a governance mechanism for updating compliance parameters, implementing new regulatory controls, and managing jurisdiction-specific requirements. Smart contracts incorporate regulatory update hooks that allow for the systematic implementation of new compliance rules while maintaining backward compatibility for existing transactions.

According to embodiments, the method 602 incorporates a regulatory compliance validation framework. In an embodiment, the deep web transaction system includes encrypted compliance data channels that maintain regulatory status information while preserving transaction privacy. Each wallet generation process may include embedded compliance parameters that enforce jurisdiction-specific requirements. The asset management system includes a transaction validation system configured to perform multi-jurisdictional compliance checks before finalizing transfers, with the capability to halt transactions that would violate regulatory requirements. According to embodiments, the asset management system maintains compliance audit trails through encrypted channels while preserving transaction privacy through zero-knowledge proofs.

According to embodiments, with reference to FIG. 3, the method 302 may include the fulfillment of a smart contract to validate the gold deposit tokens. In an embodiment, in step 306, the at least a fractional interest in the unmined gold deposit may include at least fractional ownership of the unmined gold deposit. Additionally, or alternatively, the at least a fractional interest in the unmined gold deposit may include at least fractional rights to a revenue stream from the unmined gold deposit.

According to embodiments, in step 304, the unmined gold deposit may include a verified resource estimate. Additionally, or alternatively, the unmined gold deposit may include a standards-compliant resource assessment. In an embodiment, the unmined gold deposit may include a pending resource verification. In an embodiment, the unmined gold deposit may include a geological survey. In an embodiment, the unmined gold deposit may include an assay report. In an embodiment, the unmined gold deposit may include geophysical data. In an embodiment, the unmined gold deposit may include drill core data.

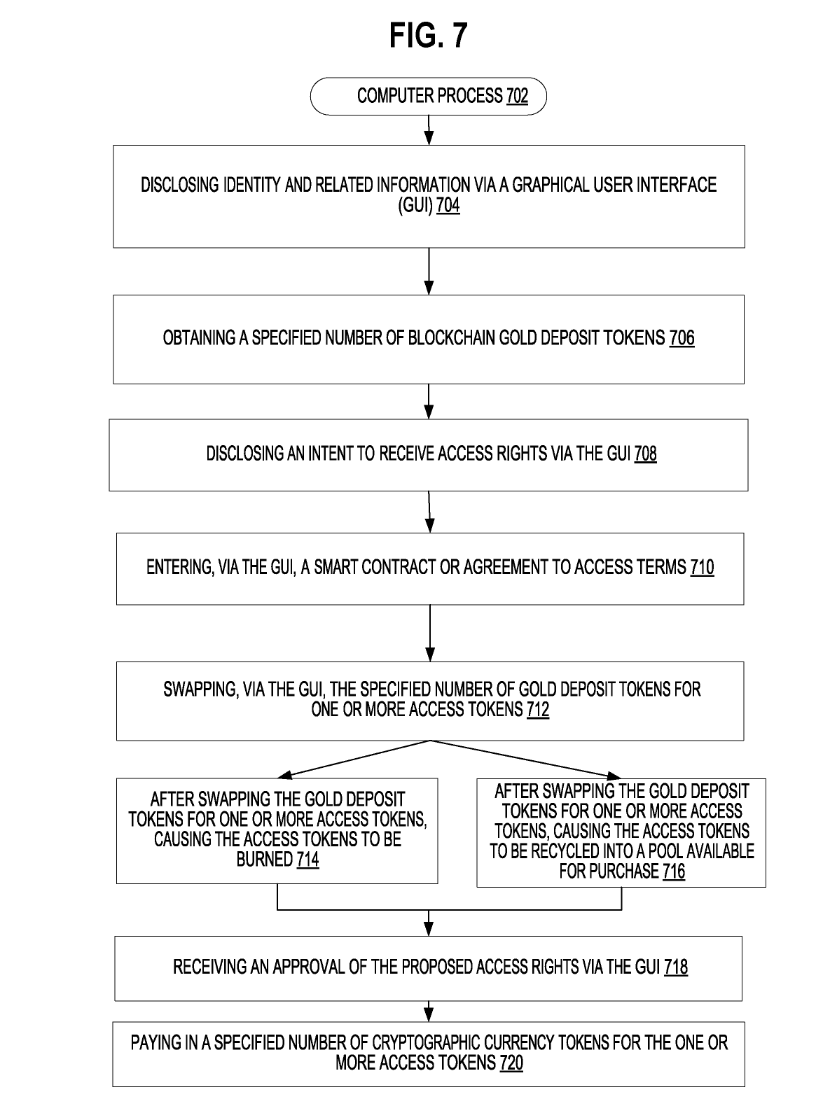

FIG. 7 is a flow chart illustrating a method 702 for receiving or obtaining access rights to an unmined gold deposit. According to embodiments, in step 704, a processing device discloses an identity and related information via a graphical user interface (GUI) on an electronic device (e.g., a user device) networked to a server computer. In an embodiment, step 704 may include establishing a user account with a digital gold exchange, using the GUI.

In step 706, a specified number of blockchain gold deposit tokens are obtained, where each token represents a fractional interest in an unmined gold deposit, by swapping a cryptographic currency value for the gold deposit tokens via the GUI. In an embodiment, the specified number of gold deposit tokens, obtained in step 706, is constant. In an embodiment, the specified number of gold deposit tokens, obtained in step 706, is variable. In an embodiment, the specified number of gold deposit tokens, obtained in step 706, is a function of a number of the gold deposit tokens, corresponding to a particular unmined gold deposit, in circulation.

In an embodiment, the specified number of gold deposit tokens is a function of the identity of the proposed token holder. For example, a lister of a gold deposit may require a larger number of tokens from a known competitor. In an embodiment, the specified number of gold deposit tokens is a function of projected annual value of the gold deposit. In an embodiment, the specified number of gold deposit tokens is a function of a size of the proposed token holder. In a solution variant, the specified number of gold deposit tokens is a function of a territory of the proposed token holder. In an embodiment, the specified number of gold deposit tokens is a function of environmental preservation commitments. In a solution variant, the specified number of gold deposit tokens is a function of a territory allowed under the access rights.

In an embodiment, the specified number of gold deposit tokens is a function of a territory excluded under the access rights. In an embodiment, the specified number of gold deposit tokens is a function of a duration of the access rights. In an embodiment, the specified number of gold deposit tokens is a function of a limitation to exploratory activities. In a solution variant, the specified number of gold deposit tokens is a function of resource estimates covered under the access rights. In an embodiment, the specified number of gold deposit tokens is a function of other considerations to be paid for the access rights or related agreement.

In step 708, an intent to receive access rights is disclosed (e.g., communicated) via the GUI. In an embodiment, the computer process 702 for obtaining access to an unmined gold deposit includes, in step 708, entering information related to intended activities via the GUI. In response to receipt of the information related to the intended activities, a server computer may assemble a list of relevant unmined gold deposits available for access according to the respective description of each. For example, the list may be assembled using, for example, Machine Learning (e.g., one or more machine learning models), Neural Networks, Bayesian logic, Boolean logic or other computing machine processes based on comparing terminology (including synonyms, noun pairs, bigrams, etc.) and relationships between terms in the intended activities description to terminology and relationships between terms in descriptions of a population of available unmined gold deposits. The approach may be similar to performing a search combined with sorting for relevance.

In step 710, a smart contract or agreement to access terms is entered via the GUI. In an embodiment, in step 710, the computer method 702 includes receiving a listing of unmined gold deposits related to the intended activities and recommended for access.

In step 712, via the GUI, the specified number of gold deposit tokens is swapped (e.g., exchanged) for one or more access tokens. In an embodiment, the access token may carry a contract granting a right to engage in activity related to the unmined gold deposit while maintaining environmental preservation. In an embodiment, the computer process 702 includes, in step 712, determining that further refinement in the intended activities description is desirable to reduce extraneous recommended listings. In an embodiment, the computer method 702 includes repeating the steps of entering intended activities information, shown in step 710, and receiving a refined listing of unmined gold deposits recommended for access.

In an embodiment, in step 714, swapping the gold deposit tokens for one or more access tokens causes the access tokens to be burned. In an embodiment, in step 716, swapping the gold deposit tokens for one or more access tokens causes the access tokens to be recycled into a pool available for purchase.

In an embodiment, the method 702 includes, in step 718, receiving an approval of the proposed access rights via the GUI. In an embodiment, obtaining a specified number of gold deposit tokens representing a fractional interest in an unmined gold deposit, in step 706, further includes obtaining a specified number of gold deposit tokens representing fractional interests in a plurality of respective unmined gold deposits. In this way, a digital gold exchange may offer bundled gold deposit packages. In an embodiment, each one of a plurality of obtained gold deposit tokens represents an interest in one unmined gold deposit. In another solution variant, one or more of the obtained gold deposit tokens represent an interest in a plurality of unmined gold deposits.

In an embodiment, swapping the specified number of gold deposit tokens for one or more access tokens, in step 720, further includes paying, in a specified number of cryptographic currency tokens, for the one or more access tokens.

According to embodiments, the gold deposit token may correspond to a verified resource estimate or pending verification. In other solution variants, the gold deposit token may correspond to exploration rights. In one or more embodiments, the gold deposit token may correspond to a distributorship, a right to resell, and/or to a franchise.

According to embodiments, the processing device integrates risk assessment protocols during the access rights acquisition process. For example, in an embodiment, i steps 704-706, the processing device may interface with the geological risk assessment algorithm and political risk scoring mechanism to evaluate access-specific risks. In an embodiment, in steps 708-712, the processing device may incorporate insurance requirement validation and risk mitigation trigger setup. In an embodiment, the processing device may maintain continuous monitoring of risk parameters throughout the access token lifecycle, with one or more adjustments based on real-time risk metric updates.

According to embodiments, method 702 represents an access rights process which implements a regulatory compliance verification layer that validates access permissions against multiple regulatory frameworks. In an embodiment, the regulatory compliance verification layer includes checks of jurisdiction-specific access restrictions, regulatory authorizations, and compliance requirements. In an embodiment, the asset management system maintains compliance state channels that track access rights modifications, regulatory approvals, and jurisdictional restrictions. Smart contracts may be employed to enforce regulatory requirements for access rights transfers, including compliance with local mining regulations, environmental preservation requirements, and jurisdictional restrictions. In an embodiment, the asset management system generates compliance reports for regulatory submissions related to access rights transfers and modifications.

FIG. 8 is a diagram illustrating an example distributed electronic ledger system 802 communicatively coupled to an asset management system 100, 800, according to embodiments. In an embodiment, the distributed electronic ledger system 802 includes a distributed ledger 816 that is stored and maintained in a decentralized manner across a plurality of participating nodes 810, in accordance with one or more embodiments of the present disclosure. In an embodiment, the distributed ledger 816 is implemented as a blockchain architecture, utilizing cryptographic linking between sequential data blocks to ensure data integrity and immutability. In an embodiment, each node 810 represents a special purpose computing device equipped with specialized software, which maintains operative communication with other nodes 810 over a secure, redundant network infrastructure.

According to embodiments, the nodes can be categorized into different operational roles, where one or more nodes are owned, managed, or otherwise operated by a managing entity system that possesses elevated privileges to write to, publish to, or otherwise communicate with the other nodes 810 in the distributed electronic ledger system 802. According to embodiments, each participating node 810 hosts either a complete copy of the distributed ledger 816 for maximum redundancy, or a partial copy based on sharding protocols used scalability.

According to embodiments, when additional data records are proposed for inclusion in the distributed ledger 816, a multi-phase validation process is initiated. One or more nodes 810 (e.g., all participating nodes) execute a validation procedure on the proposed additional data records through a consensus algorithm. According to embodiments, the validation process encompasses verification of data structure, cryptographic signatures, transaction validity, and compliance with network rules. After successful validation through the consensus mechanism, the proposed data record undergoes commitment, ensuring it is simultaneously added to each copy of the distributed ledger 816 across all participating nodes 810 in a consistent manner.

According to embodiments, the asset management system many include a compliance record maintenance system configured to utilize a specialized subset of nodes designated as compliance archival nodes. According to embodiments, these nodes maintain records of all compliance-related activities, including KYC related verifications, AML related verifications, or both, regulatory approvals, and jurisdiction-specific authorizations. According to embodiments, the asset management system implements encrypted storage of sensitive compliance data while maintaining public verifiability of compliance status through zero-knowledge proofs.

According to embodiments, the distributed electronic ledger system 802 may implement various types of consensus algorithms to ensure the integrity and authenticity of data within the distributed ledger. According to embodiments, the relationship between data validation and consensus varies by implementation. In an embodiment, validation of data records is integrated into the consensus algorithm itself. In an embodiment, validation operates as an independent computing layer that complements the consensus mechanism.

According to embodiments, monitoring actively mined deposits may include the use of a consensus mechanism including one or more additional validation layers specific to mining operation data. These layers may be used to verify the authenticity of production reports, validate extraction volumes against geological models, and ensure proper execution of token adjustment protocols. According to embodiments, the asset management system implements specialized consensus rules for handling real-time mining data feeds and executing token adjustments based on verified production metrics.

According to embodiments, the consensus mechanism implements a "proof of work" ("POW") algorithm, where nodes perform computationally intensive calculations to solve complex cryptographic puzzles. For validation of pending data records, nodes must calculate a cryptographic hash using algorithms (e.g., SHA256) that satisfies specific dynamic difficulty conditions established by the system. This process, termed "mining," transforms certain participating nodes into "miners" or "miner nodes." According to embodiments, the distributed electronic ledger system 802 implements adaptive difficulty targeting by requiring the resulting hash value to fall below a dynamically adjusted threshold. In these solution variants, nodes combine multiple elements into their calculations: a "base string" (e.g., including metadata within a block header, comprising Merkle root hashes, previous block hashes, timestamps, and version information) with a "nonce" (i.e., an incrementing numerical value). During hash calculation using the POW algorithm, the nonce is initialized to 0 and systematically incremented by 1 until a node discovers a nonce value producing a hash that satisfies the current difficulty target. Upon finding a valid solution, the successful node immediately broadcasts both the solution and its proof to all other network nodes for independent verification. Following thorough validation of the "winning" solution by other nodes through parallel verification, the pending data record is cryptographically appended to the terminal block in the distributed ledger.

According to embodiments, the distributed electronic ledger system 802 also comprises fork resolution mechanisms for cases where multiple nodes generate valid solutions within a short time window. In an embodiment, nodes implementing the POW algorithm converge on the chain demonstrating the highest cumulative proof of work (i.e., the chain requiring the greatest computational effort) as the canonical version of the distributed ledger. Any nodes maintaining divergent ledger versions execute a reconciliation protocol to synchronize with the consensus-determined canonical chain.

According to embodiments, the distributed electronic ledger system 802 employs a "proof of stake" ("PoS") algorithm, where validation authority is proportionally distributed based on participants' "stake" within the distributed ledger. The stake quantification system is multifaceted, incorporating factors such as cryptocurrency holdings, token ownership, asset shares, reputation points, or a weighted combination thereof within the distributed ledger ecosystem as it applies to the unmined gold tokens. Block creation and validation rights are allocated through a voting mechanism where voting power correlates directly with stake size. The next canonical block is determined through a weighted consensus process that considers both the number of votes and the stake-weight behind each vote. Participants with larger stakes receive proportionally greater voting allocation rights, creating an economic incentive for maintaining ledger integrity while simultaneously protecting against manipulation attempts.

According to embodiments, the distributed electronic ledger system 802 includes a "practical byzantine fault tolerance" ("PBFT") algorithm, where each node maintains and utilizes an internal state machine for validation purposes. In an embodiment, the process begins when a user or node submits a formally structured request to post a pending data record to the distributed ledger. Each participating node executes the PBFT algorithm against both the pending data record and its current internal state representation, performing rigorous validity checks and state transition calculations. Upon completion of local validation, nodes broadcast cryptographically signed votes (affirming or rejecting validity) to all other network participants. In an embodiment, the distributed electronic ledger system 802 achieves consensus through a tallying mechanism that considers both the total number of votes and the network's fault tolerance threshold. Once a qualified supermajority of nodes (typically 2f + 1 in a system tolerating f failures) have voted in favor, the pending data record is officially designated as "valid" and is atomically committed to the distributed ledger across all participating nodes.

According to embodiments, the distributed ledger 816 implements append-only semantics, prohibiting direct modification of existing data records or associated metadata within the distributed ledger structure (e.g., blocks in a blockchain). Alternative solution variants support controlled modification capabilities while maintaining audit trails through an advanced versioning system that preserves the complete history of data record versions and all modifications. This ensures the distributed ledger 816 maintains a complete, immutable history of all transactions since genesis. The system incorporates fault tolerance mechanisms - if any Node 810 becomes unavailable (due to network partitions, hardware failures, security compromises, or other disruptions), the remaining nodes 810 continue to maintain consensus and serve verified copies of the distributed ledger 816. Furthermore, the system implements data integrity protection - if data records within a particular node 810's copy of the distributed ledger 816 are compromised through deletion, unauthorized modification, or other means, the remaining nodes 810 serve as authoritative references for ledger reconstruction. The distributed electronic ledger system 802 supports multiple recovery modes: in some embodiments, compromised nodes 810 are quarantined to prevent propagation of corrupted data. In other embodiments, compromised nodes 810 execute self-healing protocols to reconstruct their local ledger copy using verified data from healthy nodes 810, coordinated through the consensus mechanism.

According to embodiment, the distributed electronic ledger system 802 is configured to interfaced with one or more central bank digital currency (CBDC) systems. In an embodiment, the one or more CBDC systems are represented as additional nodes in the distributed electronic ledger system 802. there are additional nodes. According to embodiments, these nodes (depicted as bridge node(s) 832 in FIG. 8), implement a dual consensus mechanism that satisfies both the asset management system 800 requirements and the CBDC system (or network) requirements.

According to embodiments, the one or more bridge nodes 832 execute a transaction validation process that ensures the integrity of cross-system operations. In an embodiment, the validation begins with a verification by a central bank system 834 of CBDC token authenticity through cryptographic validation of central bank signatures, ensuring that only legitimate CBDC tokens participate in cross-system transactions. In an embodiment, concurrently, the one or more bridge nodes 832 perform thorough verification of gold token backing through real-time resource verification protocols, confirming that all gold tokens involved in transactions are properly backed by verified deposits. The exchange execution mechanism ensures that settlement occurs concurrently (e.g., simultaneously) across both networks (e.g., the central bank system 834 and the asset management system 800), reducing or eliminating counterparty risk.

According to embodiments, the one or more bridge nodes 832 operatively coupled to the asset management system 800 are configured to perform one or more regulatory compliance functions. According to embodiments, the one or more bridge nodes 832 enforce transaction limits established by monetary authorities through real-time monitoring and enforcement mechanisms. According to embodiments, the one or more bridge nodes 832 provide information to a regulatory reporting system of the asset management system 800 which is configured to generate documentation of all cross-network activities, providing authorities with immediate visibility into system operations. In an embodiment, a detailed audit trail is maintained across both networks (e.g., the asset management system 800 and the central bank system 834), with cryptographic proofs ensuring the immutability of all transaction.

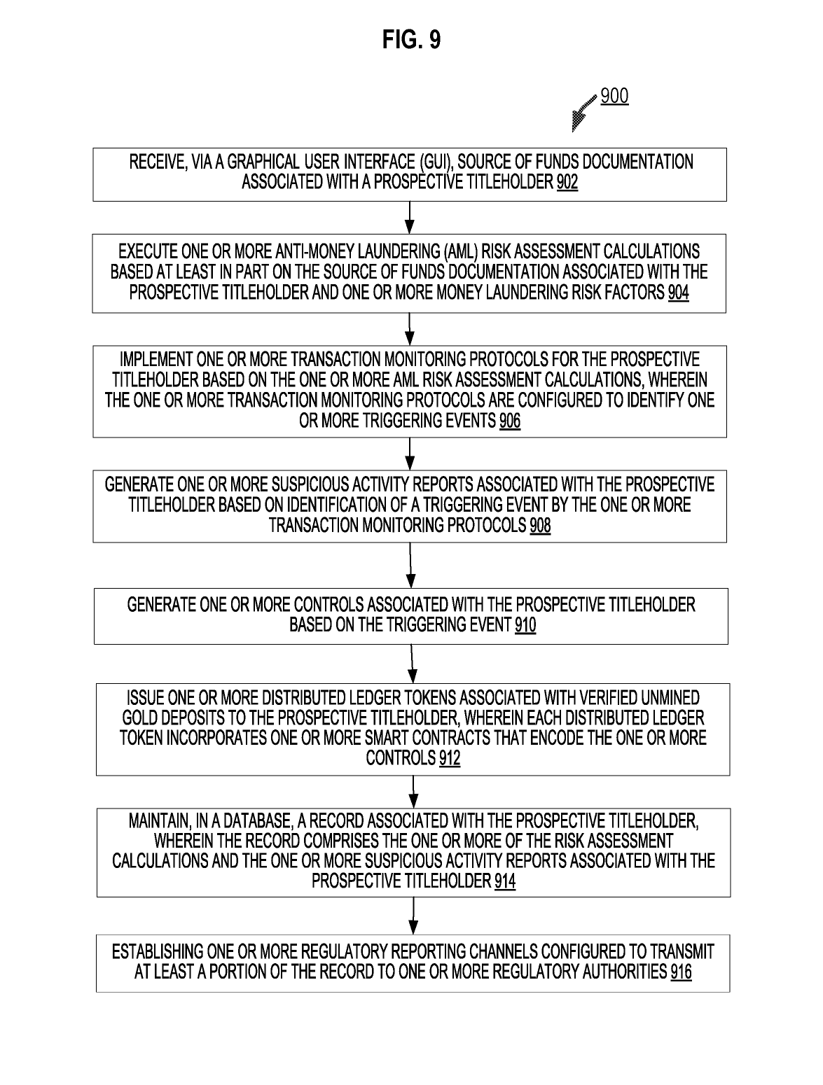

FIG. 9 is a flow diagram of an example method 900 executable by an asset management system (e.g., asset management system 100, 800 of FIGS. 1A and 8, respectively) to manage regulatory compliance (e.g., AML compliance) associated with tokenizing verified gold deposits (e.g., unmined gold deposits), according to embodiments of the present disclosure. The method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In step 902, the processing device receives, via a graphical user interface (GUI), source of funds documentation associated with a prospective titleholder. According to embodiments, the source of funds documentation includes one or more of a bank statement associated with the prospective titleholder, one or more transaction histories associated with the prospective titleholder, or asset ownership records associated with the prospective titleholder. According to embodiments, the one or more money laundering risk factors comprise one or more transaction patterns, jurisdiction risk levels, or historical financial activity.

In step 904, the processing device executes one or more anti-money laundering (AML) risk assessment calculations based at least in part on the source of funds documentation associated with the prospective titleholder and one or more money laundering risk factors.

In step 906, the processing device implements one or more transaction monitoring protocols for the prospective titleholder based on the one or more AML risk assessment calculations, wherein the one or more transaction monitoring protocols are configured to identify one or more triggering events. According to embodiments, the one or more triggering events include one or more of detected structured transactions, identified unusual transaction patterns, or flagged high-risk jurisdictional transfers.

In step 908, the processing device generates one or more suspicious activity reports associated with the prospective titleholder based on identification of a triggering event by the one or more transaction monitoring protocols.

In step 910, the processing device generates one or more controls associated with the prospective titleholder based on the triggering event. According to embodiments, the one or more controls include one or more of: establishing transaction limits, establishing holding periods, or implementing transaction screening based on the one or more AML risk assessment calculations.

In step 912, the processing device issues one or more distributed ledger tokens associated with verified unmined gold deposits to the prospective titleholder, wherein each distributed ledger token incorporates one or more smart contracts that encode the one or more controls.

In step 914, the processing device maintains, in a database, a record associated with the prospective titleholder, wherein the record comprises the one or more of the risk assessment calculations and the one or more suspicious activity reports associated with the prospective titleholder.

In step 916, the processing device establishes one or more regulatory reporting channels configured to transmit at least a portion of the record to one or more regulatory authorities.

According to embodiments, the method 900 further includes recording at least a portion of the record associated with the prospective titleholder in a secure section of a distributed ledger maintained across a network of validating nodes.

According to embodiments, the method 900 further includes implementing a transaction monitoring system that performs one or more operations comprising: establishing baseline transaction patterns for different customer categories; calculating dynamic risk thresholds based on historical activity; applying one or more machine learning algorithms to detect anomalous transactions; adjusting monitoring parameters based on detected patterns; or generating graduated alert levels based on severity of detected anomalies.

According to embodiments, the method 900 further includes maintaining a blockchain-based audit system configured to perform one or more of: recording all AML verification steps with cryptographic timestamps, maintaining immutable logs of all alert investigations, tracking reviewer decisions, implementing role-based access controls for audit records, or generating regulatory compliance reports from audit data.

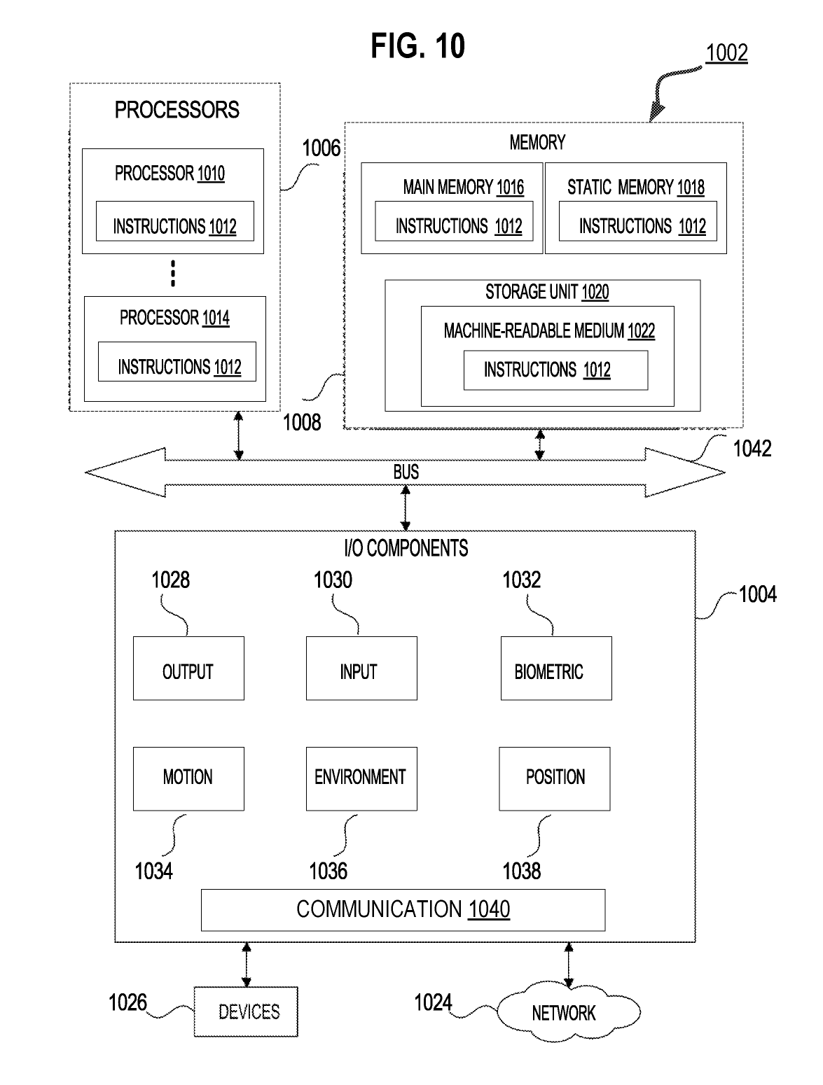

FIG. 10 is a diagrammatic representation of a variant of a machine 1002 implementing embodiments of the present disclosure (described herein with reference to the asset management system 100, 800 within which instructions 1012 (e.g., software, a program, an application, an applet, an app, or other executable code) for causing the machine 1002 and its processors 1006 or processor 1014 to perform any one or more of the methodologies discussed herein may be executed. For example, the instructions 1012 may cause the machine 1002 to execute any one or more of the methods described herein (e.g., methods described with reference to FIGS. 1A-9). The instructions 1012 transform the general, non-programmed machine 1002 into a particular machine 1002 programmed to carry out the described and illustrated functions in the manner described. The machine 1002 may operate as a standalone device or may be coupled (e.g., networked) to other machines in a local and/or cloud instance.. In a networked deployment, the machine 1002 may operate in the capacity of a server machine or a client machine in a server-client network environment, or as a peer machine in a peer-to-peer (or distributed) network environment. The machine 1002 may comprise, but not be limited to, a server computer, a client computer, a personal computer (PC), a tablet computer, a laptop computer, a netbook, a PDA, a cellular telephone, a smart phone, a mobile device, a wearable device, other smart devices, a web appliance, a network router, a network switch, a network bridge, or any machine capable of executing the instructions 1012, sequentially or otherwise, that specify actions to be taken by the machine 1002. Further, while only a single machine 1002 is illustrated, the term “machine” shall also be taken to include a collection of machines that individually or jointly execute the instructions 1012 to perform any one or more of the methodologies of this solution as discussed herein.

The machine 1002 may include processors 1006, memory 1008, and I/O components 1004, which may be configured to communicate with each other via a bus 1042. In an example of the solution, the processors 1006 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a processor 1010 and a processor 1014 that execute the instructions 1012. In an embodiment, the term “processor” is intended to include multi-core processors that may comprise two or more independent processors (sometimes referred to as “cores”) that may execute instructions contemporaneously. Although FIG. 10 shows multiple processors 1006, the machine 1002 may include a single processor with a single core, a single processor with multiple cores (e.g., a multi-core processor), multiple processors with a single core, multiple processors with multiples cores, or any combination thereof.

The memory 1008 includes a main memory 1016, a static memory 1018, and a storage unit 1020, both accessible to the processors 1006 via the bus 1042. The main memory 1016, the static memory 1018, and storage unit 1020 store the instructions 1012 embodying any one or more of the methodologies or functions described herein. The instructions 1012 may also reside, completely or partially, within the main memory 1016, within the static memory 1018, within machine-readable medium 1022 within the storage unit 1020 within at least one of the processors 1006 (e.g., within the processor's cache memory), or any suitable combination thereof, during execution thereof by the machine 1002.

The I/O components 1004 may include a wide variety of components to receive input, provide output, produce output, transmit information, exchange information, capture measurements, and so on. The specific I/O components 1004 that are included in a particular machine will depend on the type of machine. For example, portable machines such as mobile phones may include a touch input device or other such input mechanisms, while a headless server machine will likely not include such a touch input device. It will be appreciated that the I/O components 1004 may include many other components that are not shown in FIG. 10. In various example of the solutions, the I/O components 1004 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example of the solutions, the I/O components 1004 may include biometric components 1032, motion components 1034, environmental components 1036, or position components 1038, among a wide array of other components. For example, the biometric components 1032 of this solution include components to uniquely key to a particular user to a particular token as identified by the solution and the like.

Communication may be implemented using a wide variety of technologies. The I/O components 1004 further include communication components 1040 operable to couple the machine 1002 to a network 1024 or devices 1026 via respective coupling or connections. For example, the communication components 1040 may include a network interface component or another suitable device to interface with the network 1024. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1026 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and/or memory of the processors 1006) and/or storage unit 1020 may store one or more sets of instructions and data structures (e.g., software) embodying or used by any one or more of the methodologies or functions described herein. These instructions (e.g., the instructions 1012), when executed by processors 1006 cause various operations to implement the disclosed examples of the solutions.

The 1012 may be transmitted or received over the network 1024, using a transmission medium, via a network interface device (e.g., a network interface component included in the communication position components 1038) and using any one of several well-known transfer protocols (e.g., hypertext transfer protocol (HTTP)). Similarly, the instructions 1010 may be transmitted or received using a transmission medium via a coupling (e.g., a peer-to-peer coupling) to the devices 1026 or alternatively one or more Nodes 810 in a Distributed Ledger 816 system.

According to embodiments, the asset management system (e.g., asset management system 100, 800 of FIGS. 1A and 8, respectively) is configured to perform a method for tokenizing verified gold deposits, including: receiving, via a graphical user interface (GUI) into a server computer (e.g., a computing device of the asset management system), proof of title and ownership rights to at least one gold deposit in at least one specified location, wherein such proof includes documentation of unencumbered transfer of all associated rights and interests; receiving, via the GUI into the server computer, resource verification documentation compliant with at least one of NI 43-101 and S-K 1300 standards corresponding to the at least one gold deposit; establishing, with the server computer, secure data connections with mining operation systems associated with any actively mined portions of the at least one gold deposit, wherein such connections enable real-time monitoring of extraction data and production metrics; calculating, with the server computer, a total quantity of distributable tokens based on the resource verification documentation and real-time mining data, applying predetermined risk adjustment factors including historical extraction probabilities, technical feasibility parameters, and verified production rates from active mining operations; generating, with the server computer, a standardized unit value for each distributed ledger token, wherein each token represents an equal, fungible fraction of the total unmined portion of the at least one gold deposit, and implementing dynamic adjustment mechanisms based on verified production data; receiving, via the GUI into the server computer, a signature from the titleholder confirming assignment of rights to the gold deposit corresponding to the calculated total quantity of distributable tokens; issuing, with the server computer, an initial quantity of distributed ledger tokens not exceeding the calculated total quantity, each distributed ledger token incorporating a smart contract that: comprises a reference to the gold deposit, a standardized unit value, token holder rights, establishes a set of transfer restrictions, implements token adjustment protocols based on verified mining production data, and defines multi-signature requirements for validating production reports; recording the issuance of the distributed ledger tokens in a distributed ledger maintained across a network of validating nodes, wherein such nodes implement specialized consensus mechanisms for validating mining operation data and executing token adjustments; implementing, with the server computer, continuous monitoring and verification protocols for mining operations, including reconciliation of geological models with actual production data, validation of extraction volumes, and execution of token supply adjustments based on verified production metrics; crediting, with the server computer, the initial quantity of the issued distributed ledger tokens to the titleholder by transferring the distributed ledger tokens to an electronic wallet owned by the titleholder; and maintaining, with the server computer, audit trails of all production-based token adjustments and mining operation milestones that affect token supply or value.

According to embodiments, implementing continuous monitoring and verification protocols may include: receiving real-time mining operation data feeds through secure API endpoints, wherein such data feeds include extraction volumes, grade measurements, and reconciliation data; validating the received mining operation data through a multi-stage verification process including: comparison against established geological models; verification by qualified persons designated within the smart contract system; independent auditor review of material variations from predicted values; and executing smart contract-based token adjustments only after achieving consensus through a predetermined number of validating nodes, where such consensus requires multi-signature approval from designated operational stakeholders, qualified persons, and independent auditors.

According to embodiments, the asset management system may employ a smart contract which is incorporated into each distributed ledger token, where each smart contract includes one or more of: predetermined mining operation milestones that trigger token supply adjustments, where such milestones include one or more of: initiation of mining activities, achievement of commercial production levels, material changes in reserve calculations, and completion of mining in defined blocks or zones; rate-limiting controls that restrict the frequency and magnitude of token supply adjustments; reconciliation protocols that compare actual production metrics against geological models and initial resource estimates; and recovery mechanisms for reversing token adjustments in case of operational errors or legal proceedings, wherein such recovery requires multi-signature approval from designated authorities within the network.

According to embodiments, the asset management system (e.g., asset management system 100, 800 of FIGS. 1A and 8, respectively) may include a non-transitory computer-readable storage medium including instructions that when executed by a computer, cause the computer to execute operations including: receiving, via a graphical user interface (GUI), proof of title and ownership rights to at least one gold deposit in at least one specified location, wherein such proof includes documentation of unencumbered transfer of all associated rights and interests; receiving, via the GUI, resource verification documentation compliant with at least one of NI 43-101 and S-K 1300 standards corresponding to the at least one gold deposit; establishing secure data connections with mining operation systems associated with any actively mined portions of the at least one gold deposit, wherein such connections enable real-time monitoring of extraction data and production metrics; calculating a total quantity of distributable tokens based on the resource verification documentation and real-time mining data, applying predetermined risk adjustment factors including historical extraction probabilities, technical feasibility parameters, and verified production rates from active mining operations; generating a standardized unit value for each distributed ledger token, wherein each token represents an equal, fungible fraction of the total unmined portion of the at least one gold deposit, and implementing dynamic adjustment mechanisms based on verified production data; receiving, via the GUI, a signature from the titleholder confirming assignment of rights to the gold deposit corresponding to the calculated total quantity of distributable tokens; issuing an initial quantity of distributed ledger tokens not exceeding the calculated total quantity, each distributed ledger token incorporating a smart contract that: comprises a reference to the gold deposit, a standardized unit value, token holder rights, establishes a set of transfer restrictions, implements token adjustment protocols based on verified mining production data, and defines multi-signature requirements for validating production reports; recording the issuance of the distributed ledger tokens in a distributed ledger maintained across a network of validating nodes, wherein such nodes implement specialized consensus mechanisms for validating mining operation data and executing token adjustments; implementing continuous monitoring and verification protocols for mining operations, including reconciliation of geological models with actual production data, validation of extraction volumes, and execution of token supply adjustments based on verified production metrics; crediting the initial quantity of the issued distributed ledger tokens to the titleholder by transferring the distributed ledger tokens to an electronic wallet owned by the titleholder; and maintaining audit trails of all production-based token adjustments and mining operation milestones that affect token supply or value.

The detailed description serves as an illustrative example, and it is not exhaustive of all potential implementation variants. Due to the impracticality of describing every conceivable blockchain solution—whether using current consensus mechanisms or those developed after this patent's filing—alternate configurations may exist that still fall within the scope of the claims.

Throughout this specification, references to singular instances of nodes, blocks, or transactions includes plural instances, and vice versa. Likewise, while blockchain operations are described separately, they can be performed concurrently or in a different sequence than presented. Components or functionalities described as separate in example configurations (such as mining and validation) may be combined, while those presented as a single entity may be divided into multiple components. These and other modifications or improvements to the blockchain architecture remain within the bounds of the described embodiments.

In certain implementation variants, blockchain logic, smart contracts, consensus algorithms, or cryptographic operations may be executed via software (e.g., code on a non-transitory, machine-readable medium) or hardware (e.g., specialized mining processors). In a hardware context, these operations can be physical, tangible units configured in specific ways, such as through application-specific integrated circuits (ASICs) or mining-specific processors. Alternatively, they may leverage general-purpose processors configured temporarily via software to execute specific blockchain operations. Decisions on whether to implement consensus mechanisms in dedicated hardware, software, or hybrid solutions may depend on energy efficiency, hash rate requirements, or other constraints.

For purposes of clarity, "blockchain node" should be understood to mean a tangible entity that can either be physically constructed or configured (permanently or temporarily) to operate in a specific manner within the network. If temporarily configured via software, a general-purpose processor may act as various types of nodes at different times. This flexibility enables the same processor to perform multiple functions dynamically, depending on the network's current needs.

Inter-node communication between blockchain participants may occur through peer-to-peer networks or other distributed systems. When nodes process blocks at different times, data can be stored and retrieved from distributed ledgers, enabling asynchronous operation. For instance, a mining node may execute a proof-of-work operation and broadcast its results to the network, allowing other nodes to validate and process the information later.

The operations of blockchain methods described in various implementation variants may be partially or fully implemented by one or more nodes. These nodes may be physically located within a single network or distributed across multiple systems, enabling decentralized processing. In some cases, these systems may be in a centralized pool, like a mining farm, while in other cases, they could be spread across multiple geographic locations. When nodes are distributed, they may communicate and coordinate their tasks via blockchain protocols, forming a cohesive network.

Terminology used herein, such as "mining," "validation," or "consensus," refers to the manipulation of data in cryptographic forms, such as hashes, digital signatures, or Merkle trees. When the specification refers to "one implementation variant" or "an implementation variant," it indicates that the described feature may be applicable to at least one possible blockchain solution. This should not imply that all instances of the phrase refer to the same implementation variant.

Additionally, terms like "comprises," "including," and their variants are intended to imply non-exclusive inclusion. For instance, a blockchain method that "comprises" certain elements is not limited to those elements alone and includes other components not explicitly listed. Similarly, "or" should be interpreted as inclusive unless otherwise specified, meaning proof-of-work or proof-of-stake could be implemented individually or in hybrid forms.

The descriptions provided are intended as illustrative, non-exhaustive examples of blockchain implementations. They do not define every possible implementation variant, as doing so would be impractical, if not impossible. Moreover, technological advancements in cryptography, consensus mechanisms, and alternate configurations may arise that still fall within the scope of the present disclosure.

What is claimed is:

1. A method comprising:
receiving, by a processing device via a graphical user interface (GUI), source of funds documentation associated with a prospective titleholder;
executing one or more anti-money laundering (AML) risk assessment calculations based at least in part on the source of funds documentation associated with the prospective titleholder and one or more money laundering risk factors;
implementing one or more transaction monitoring protocols for the prospective titleholder based on the one or more AML risk assessment calculations, wherein the one or more transaction monitoring protocols are configured to identify one or more triggering events;
generating one or more suspicious activity reports associated with the prospective titleholder based on identification of a triggering event by the one or more transaction monitoring protocols;
generating one or more controls associated with the prospective titleholder based on the triggering event;
issuing one or more distributed ledger tokens associated with verified unmined gold deposits to the prospective titleholder, wherein each distributed ledger token incorporates one or more smart contracts that encode the one or more controls;
maintaining, in a database, a record associated with the prospective titleholder, wherein the record comprises the one or more of the AML risk assessment calculations and the one or more suspicious activity reports associated with the prospective titleholder; and
establishing one or more regulatory reporting channels configured to transmit at least a portion of the record to one or more regulatory authorities.

2. The method of claim 1, wherein the source of funds documentation comprises one or more of a bank statement associated with the prospective titleholder, one or more transaction histories associated with the prospective titleholder, or asset ownership records associated with the prospective titleholder.

3. The method of claim 1, wherein the one or more money laundering risk factors comprise one or more transaction patterns, jurisdiction risk levels, or historical financial activity.

4. The method of claim 1, wherein the one or more triggering events comprise one or more of detected structured transactions, identified unusual transaction patterns, or flagged high-risk jurisdictional transfers.

5. The method of claim 1, wherein the one or more controls comprise one or more of: establishing transaction limits, establishing holding periods, or implementing transaction screening based on the one or more AML risk assessment calculations.

6. The method of claim 1, further comprising recording at least a portion of the record associated with the prospective titleholder in a secure section of a distributed ledger maintained across a network of validating nodes.

7. The method of claim 1, further comprising implementing a transaction monitoring system that performs one or more operations comprising: establishing baseline transaction patterns for different customer categories; calculating dynamic risk thresholds based on historical activity; applying one or more machine learning algorithms to detect anomalous transactions; adjusting monitoring parameters based on detected patterns; or generating graduated alert levels based on severity of detected anomalies.

8. The method of claim 1, further comprising maintaining a blockchain-based audit system configured to perform one or more of: recording all AML verification steps with cryptographic timestamps, maintaining immutable logs of all alert investigations, tracking reviewer decisions, implementing role-based access controls for audit records, or generating regulatory compliance reports from audit data.

9. A system comprising:
a memory to store instructions; and
a processing device operatively coupled to the memory, the processing device to execute the instructions to perform operations comprising:
receiving, via a graphical user interface (GUI), source of funds documentation associated with a prospective titleholder;
executing one or more anti-money laundering (AML) risk assessment calculations based at least in part on the source of funds documentation associated with the prospective titleholder and one or more money laundering risk factors;
implementing one or more transaction monitoring protocols for the prospective titleholder based on the one or more AML risk assessment calculations, wherein the one or more transaction monitoring protocols are configured to identify one or more triggering events;
generating one or more suspicious activity reports associated with the prospective titleholder based on identification of a triggering event by the one or more transaction monitoring protocols;
generating one or more controls associated with the prospective titleholder based on the triggering event;
issuing one or more distributed ledger tokens associated with verified unmined gold deposits to the prospective titleholder, wherein each distributed ledger token incorporates one or more smart contracts that encode the one or more controls;
maintaining, in a database, a record associated with the prospective titleholder, wherein the record comprises the one or more of the risk assessment calculations and the one or more suspicious activity reports associated with the prospective titleholder; and
establishing one or more regulatory reporting channels configured to transmit at least a portion of the record to one or more regulatory authorities.

10. The system of claim 9, wherein the source of funds documentation comprises one or more of a bank statement associated with the prospective titleholder, one or more transaction histories associated with the prospective titleholder, or asset ownership records associated with the prospective titleholder.

11. The system of claim 9, wherein the one or more money laundering risk factors comprise one or more transaction patterns, jurisdiction risk levels, or historical financial activity.

12. The system of claim 9, wherein the one or more triggering events comprise one or more of detected structured transactions, identified unusual transaction patterns, or flagged high-risk jurisdictional transfers.

13. The system of claim 9, wherein the one or more controls comprise one or more of: establishing transaction limits, establishing holding periods, or implementing transaction screening based on the risk assessment calculations.

14. The system of claim 9, wherein the operations further comprise recording at least a portion of the record associated with the prospective titleholder in a secure section of a distributed ledger maintained across a network of validating nodes.

15. The system of claim 9, wherein the operations further comprise implementing a transaction monitoring system that performs one or more operations comprising: establishing baseline transaction patterns for different customer categories; calculating dynamic risk thresholds based on historical activity; applying one or more machine learning algorithms to detect anomalous transactions; adjusting monitoring parameters based on detected patterns; or generating graduated alert levels based on severity of detected anomalies.

16. The system of claim 9, wherein the operations further comprise maintaining a blockchain-based audit system configured to perform one or more of: recording all AML verification steps with cryptographic timestamps, maintaining immutable logs of all alert investigations, tracking reviewer decisions, implementing role-based access controls for audit records, or generating regulatory compliance reports from audit data.

17. A method comprising:
receiving, by a processing device via a user interface, identification documentation from a prospective titleholder;
validating the identification documentation using one or more verification sources;
executing one or more due diligence protocols associated with the prospective titleholder, the due diligence protocols comprising verification of one or more ownership structures associated with the prospective titleholder;
generating a risk score associated with the prospective titleholder based on one or more risk factors;
generating, based on the risk score, a know-your-customer (KYC) verification report associated with the prospective titleholder, wherein the verification report comprises one or more transaction parameters;
issuing one or more distributed ledger tokens to the prospective titleholder, wherein each distributed ledger token incorporates a smart contract that encodes the KYC verification report;
maintaining, in a database, a record comprising the KYC verification report; and
recording the record associated with the prospective titleholder in a distributed ledger maintained across a network of nodes.

18. The method of claim 17, wherein the verification report comprises information documenting one or more identity checks or risk assessments associated with the prospective titleholder.

19. The method of claim 17, wherein the KYC verification report comprises the identification documentation, the one or more due diligence protocols, and the risk score associated with the prospective titleholder.

20. The method of claim 17, further comprising implementing a periodic review of the prospective titleholder, wherein the periodic review comprises one or more of: scheduling risk-based review frequencies for the prospective titleholder, triggering document renewal requests, validating updated customer information, reassessing the risk score based on updated information, or maintaining a compliance calendar for required review cycles.
